(19) United States
(12) Patent Application Publication
(10) Pub. No.: US 2020/0024393 A1
(43) Pub. Date: Jan. 23, 2020

(54) POLYMERS AND PROCESS FOR THEIR MANUFACTURE

(71) Applicant: Victrex Manufacturing Limited, Thomton Cleveleys, Lancashire (GB)

(72) Inventors: Nathan Allcock, Thornton Cleveleys, Lancashire (GB); Richard Ainsworth, Thornton Cleveleys, Lancashire (GB); Glynn Harrington, Thornton Cleveleys, Lancashire (GB); James Sherrington, Thornton Cleveleys, Lancashire (GB); Nigel Slater, Thornton Cleveleys, Lancashire (GB)

(21) Appl. No.: 16/336,420

(22) PCT Filed: Sep. 21, 2017
(86) PCT No.: PCT/GB2017/052827

§ 371 Date: Mar. 25, 2019

(30) Foreign Application Priority Data
Sep. 26, 2016 (GB) 1616320.6
Mar. 15, 2017 (GB) 1704135.1

(51) Int. Cl. C08G 65/40; C08L 71/12

(52) U.S. Cl. CPC C08G 65/4093; C08G 65/4012; C08L 71/123; C08G 2650/40; C08G 2140/00; C08L 2203/18; C08L 2203/202; C08L 2203/206; C08L 2203/16

(57) ABSTRACT

There is disclosed polymers, a process for manufacturing polymers and uses of the polymers. The polymers are polyaryl ether ketones and the process includes a nucleophilic polycondensation of a bisphenol with an organic dihalide compound in a reaction mixture comprising sodium carbonate and potassium carbonate, in an aromatic sulfone solvent, at a reaction temperature rising to a temperature from 290° C. to 320° C. immediately prior to the addition of a salt to the reaction mixture, wherein the molar ratio of the salt to potassium carbonate is from 6.0 to 10.0. Further organic dihalide compound is added to the reaction mixture wherein the molar ratio of further organic dihalide compound to bisphenol is from 0.009 to 0.035. The resulting reaction mixture is maintained at a temperature at from 290° C. to 320° C. for from 20 to 180 minutes and then the resulting reaction mixture is cooled and the PAEK recovered.

This invention relates to polymers, processes for manufacturing the polymers and uses of the polymers.

There is a wide range of thermoplastic polymeric materials available for use in industry, either alone or as part of composite materials. However, industry is constantly demanding materials with properties that are improved in at least some respect over existing materials.

Polyaryletherketones (PAEKs) such as polyetheretherketone (PEEK) are often used. PEEK is the material of choice for many commercial applications because it is highly crystalline and has outstanding chemical resistance properties. PAEKs, particularly including PEEK, can be manufactured by nucleophilic polycondensation of bisphenols with organic dihalide compounds in a suitable solvent in the presence of alkali metal carbonates and/or bicarbonates or alkaline earth metal carbonates and/or bicarbonates. Such processes are set out, for example, in EP0001879A, EP0182648A, EP0244167A and EP3049457A.

While PAEKs may exhibit mechanical properties that are acceptable in a number of applications, it would be beneficial to provide PAEKs that demonstrate improved mechanical properties such as fracture toughness. Fracture toughness testing measures the energy required to propagate a crack through a test bar until the bar breaks. The propagation of a crack requires less energy in brittle materials than in ductile/tough materials. A material with higher fracture toughness characteristics is better suited than a material with lower fracture toughness for use in thicker walled parts (e.g. stock shapes including rods, machined components, in extruded and injection moulded articles such as pipes and casings and in composites generally).

Furthermore, there is a need in a number of areas (for example in the electronics industry for components for mobile phones, tablets etc.) for thermoplastic polymeric materials that exhibit as light or as white a colour as possible, e.g. compositions that exhibit a higher lightness, L* (according to the 1976 CIE L* a* b* colour space). Components manufactured from such compositions are useful because they enable ease of colour matching with similarly white-coloured components. It is easier to adjust the colour and/or match (e.g. by addition of colourants) a lighter polymer compared to e.g. the light brown/beige colour of known PEEKs. Furthermore, in general, light or white polymers and lighter or whiter components made therefrom are desirable since whiteness implies higher purity and quality.

Additionally, it would be beneficial to provide a PAEK that exhibits a lower incidence of gel formation. PAEKs have a tendency to contain small amounts of very high molecular mass, branched and cross-linked material, which can cause visual defects, particularly evidenced in thin films and commonly known as fish-eyes. Such defects reduce the effective yield of good quality, defect-free polymer film, and hence increase the amount of material that must be scrapped. Gels can also lead to processing, quality and yield issues in the manufacture of melt-spun fibres.

A conventional commercial route for the formation of PAEKs and particularly PEEK is by nucleophilic polycondensation of one or more bisphenols with one or more organic dihalide compounds, in the presence of alkali metal or alkali earth metal carbonates or bicarbonates, leading to the presence of organic dihalide compounds as residual impurities in the resulting polymer. Even after extensive washing of the polymer by solvents, residual levels of organic dihalide compounds in the resulting PAEK, particularly levels of 4,4′ difluorobenzophenone in PEEK, when this monomer is used for PEEK polycondensation, may be undesirably high. If the PAEK or PEEK is intended for use in contact with foods or pharmaceutical compounds, it is desirable to reduce the levels of such residues and/or to facilitate their removal from the PAEK or PEEK.

Furthermore, the conventional nucleophilic polycondensation route may lead to residual polymerisation reaction solvent, typically residual diphenyl sulfone (DPS) being present in the PAEK or PEEK, even after extensive washing of the polymer with solvents intended to remove residual polymerisation reaction solvent. Such residual polymerisation solvent may lead to problems when the PAEK or PEEK is subsequently processed by melt-processing such as extrusion or injection moulding. For instance the polymerisation solvent may migrate to surfaces leading to formation of localised solvent droplets or particles in a product, potentially generating product defects. It is thus desirable to reduce the levels of such polymerization solvent residues, such as DPS residues, and/or to facilitate their removal from the PAEK or PEEK.

Accordingly there is a need for a polymeric PAEK, and particularly PEEK material that has one or more of the following: improved mechanical properties, lighter or whiter colour, reduced incidence of gel formation, reduced residual organic dihalide compounds, such as 4,4′-difluorobenzophenone, and reduced residual polymerisation solvent such as reduced DPS residues. There is also a need for an industrially applicable process for preparing such PAEK or PEEK.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

All references to L*, a* and b* values in the present application are when measured in accordance with Example 6 and with reference to the 1976 CIE L* a* b* colour space.

As used herein, the term “nucleophilic condensation” is used to refer briefly to the process for preparation of PAEK, particularly PEEK, by nucleophilic polycondensation of bisphenols with organic dihalide compounds, in the presence of alkali and/or alkali earth metal carbonates and/or bicarbonates in the presence of a polymerisation solvent such as diphenyl sulfone (DPS). For PEEK, the bisphenol is preferably hydroquinone and the organic dihalide compound is preferably 4,4′-difluorobenzophenone.

References to the monomers, solvents and other additives of the nucleophilic condensation reaction are meant to refer to these compounds with their commercially available purities, without further special purification.

The invention provides a process for producing polyaryletherketone (PAEK), the process comprising:

a nucleophilic polycondensation of a bisphenol with an organic dihalide compound in a reaction mixture comprising sodium carbonate and potassium carbonate, in an aromatic sulfone solvent, at a reaction temperature rising to a temperature from 290° C. to 320° C. immediately prior to;

b addition of a salt to the reaction mixture, wherein the molar ratio of the salt to potassium carbonate is from 6.0 to 10.0;

c addition of further organic dihalide compound to the reaction mixture, simultaneously with or subsequent to step b, wherein the molar ratio of further organic dihalide compound to bisphenol is from 0.009 to 0.035;

d maintenance of the resulting reaction mixture's temperature at from 290° C. to 320° C. for from 20 to 180 minutes;

e cooling of the resulting reaction mixture and recovery of the PAEK resulting from steps a to d from the reaction mixture;

wherein in step a of the process:

i the molar ratio of sodium carbonate to bisphenol is from 0.95 to 1.15;

ii the molar ratio of potassium carbonate to sodium carbonate is from 0.0025 to 0.0040; and

iii the molar ratio of organic dihalide compound to bisphenol is from 1.005 to 1.010.

In step a of the process, the reaction temperature may be maintained at a temperature from 290° C. to 320° C. until a desired molecular mass of the PAEK has been reached. This may be assessed by monitoring the measured torque of a stirrer motor driving a stirrer paddle in the reaction mixture which has been calibrated to correlate the measured torque with the molecular mass of PAEK reached by polycondensation. More preferably, the reaction temperature may be maintained at a temperature from 300° C. to 312° C.

Once the desired molecular mass of the PAEK has been reached, the salt is added to the reactor to act as a reaction-stopping agent.

The salt may be an alkali metal salt or an alkaline earth metal salt. The salt may be selected from lithium chloride, calcium chloride, magnesium chloride, lithium bromide, lithium iodide and/or lithium sulphate. In one example, the salt is preferably lithium chloride. In another example the salt is preferably lithium sulphate. The molar equivalents of the salt (relative to the moles of potassium carbonate present in step a of the process) may be at least 1.0 molar equivalents, preferably at least 4.0 molar equivalents, more preferably at least 6.0 molar equivalents, most preferably at least 7.0 molar equivalents. The molar equivalents of the salt may be less than 15.0 molar equivalents, preferably less than 12.0 molar equivalents, more preferably less than 10.0 molar equivalents, most preferably less than 9.0 molar equivalents.

The molar ratio of potassium carbonate may alternatively be defined as the molar ratio of potassium carbonate to bisphenol and may range from 0.0025 to 0.0046.

The further organic dihalide compound is added to the reaction mixture in step c, simultaneously with the addition of step b, or subsequent to completion of the addition of step b. For instance the addition of step c may commence part-way through the addition of step b and end after step b has been completed.

Preferably, the addition of step c is completed within 10 minutes of the commencement of step b, and more preferably, to prevent reduction in the PAEK molecular mass, step c does not commence until after the completion of the addition of step b. Typically, the addition of step b will be over a period of 5 minutes or less, as will the addition of step c.

In step d, the resulting reaction mixture's temperature is maintained at from 290° C. to 320° C. for from 20 to 180 minutes. In this step, a preferred maintained temperature is from 300° C. to 312° C. The temperature may be maintained at a temperature from 290° C. to 320° C., preferably from 300° C. to 312° C., more preferably 305° C. to 308° C. for from 20 to 180 minutes, preferably from 20 to 120 minutes, more preferably from 20 to 60 minutes, even more preferably from 30 to 60 minutes, prior to the cooling of step e.

In step e, the reaction mixture is typically cooled by discharging the reaction mixture onto a water-cooled surface.

Once cool, the PAEK may be recovered by processes known in the art. Typically, the crude cooled reaction product may be milled into a coarse powder, for instance with less than 2 mm maximum dimension. The powder may be washed in a separating column with an organic solvent, preferably a partially water-miscible solvent such as acetone, to remove organic impurities, specifically to remove aromatic sulfone solvent. Typically, acetone may be passed through the column until aromatic sulfone solvent, such as diphenylsulfone, is no longer precipitated out of organic wash on addition of water to the wash. The remaining product may then be washed with ambient temperature deionised water to remove the organic solvent, such as acetone, prior to further washing with hot (e.g. 90° C.) deionised water to remove water-soluble residues such as sodium and potassium salts. This may be monitored by monitoring the conductivity of the wash water. Once this has reached a minimal level, the material remaining may be dried to yield the recovered PAEK.

Typically, the reaction mixture in step a will be formed with the reaction mixture at a temperature of 130° C. or more, then heated to a target polymerisation range for the reaction mixture temperature from 290° C. to 320° C. Typically, the reaction mixture may be gradually heated to the target polymerisation range over a period of 1 to 6 hours before a temperature in the target polymerisation range is reached, This may be achieved by continuous heating, or by heating to intermediate “hold” temperatures, with the reaction mix held at a “hold” temperature such as 200° C. or 220° C. for 20 to 60 minutes the reaction mixture temperature reaches the target polymerisation range, the reaction mixture may be held at a temperature within the target polymerisation range for a period from 20 to 360 minutes, preferably from 30 to 240 minutes, more preferably from 60 to 90 minutes, prior to commencement of step b.

In the process, sodium bicarbonate or a mixture of sodium bicarbonate and sodium carbonate may be considered as equivalent to sodium carbonate based upon providing the same molar equivalence of sodium ions to the reaction mixture.

In the process, potassium bicarbonate or a mixture of potassium bicarbonate and potassium carbonate may be considered as equivalent to potassium carbonate based upon providing the same molar equivalence of potassium ions to the reaction mixture.

The aromatic sulfone solvent used in the process may suitably be a solvent of formula

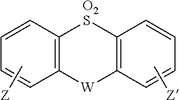

where W is a direct link, an oxygen atom or two hydrogen atoms (one attached to each benzene ring) and Z and Z′, which may be the same or different, are hydrogen atoms or phenyl groups. A mixture of such solvents may be used. Examples of such aromatic sulfones include diphenylsulfone, dibenzothiophen dioxide, phenoxanthin dioxide and 4-phenylsulfonyl biphenyl. Diphenylsulfone is a preferred solvent. Step a of the process is preferably carried out in the presence of diphenylsulfone as solvent. References to diphenylsulfone as solvent mean that the solvent comprises at least 95% by weight of diphenylsulfone.

In step a of the process the molar ratio of potassium carbonate to sodium carbonate is from 0.0025 to 0.0040 preferably from 0.0030 to 0.0036, more preferably less than 0.0034. Preferably step a of the process is carried out in the presence of greater than 0.0025 molar ratio of potassium carbonate. These preferred ranges provide benefits in terms of increased speed of reaction whilst avoiding side reactions, in particular excessive chain branching that can occur if the rate of reaction is too low.

The molar ratio of sodium carbonate to bisphenol in step a is from 0.95 to 1.15. The molar ratio may be greater than 0.95, preferably 1.00 or more, preferably greater than 1.00, more preferably greater than 1.01, most preferably greater than 1.02. The molar ratio may be less than 1.15, preferably less than 1.10, more preferably less than 1.06, most preferably less than 1.04.

The molar ratio of carbonates to bisphenol, for carbonates other than sodium carbonate and potassium carbonate (and their equivalents if bicarbonates are included), used in step a of the process is preferably less than 0.05, more preferably less than 0.01.

Preferably, the only carbonates used in step a of the process are sodium carbonate and potassium carbonate (including their bicarbonate equivalents). Even more preferably, the bicarbonate equivalents are excluded.

In step b of the process the molar ratio of salt, for example, lithium chloride, to potassium carbonate is from 6.0 to 10.0, preferably from 7.0 to 9.0.

Step a of the process has the molar ratio of organic dihalide compound to bisphenol from 1.005 to 1.010. This is preferably from 1.006 to 1.008. The molar ratio of organic dihalide compound is defined as the number of moles of organic dihalide compound used in step a of the process divided by the total number of moles of bisphenol used in step a of the process.

The bisphenol may be or comprise hydroquinone, 4,4′-dihydroxybenzophenone, 4,4′-dihydroxybiphenyl, 4,4′-dihydroxydiphenyl ether, 1,4-dihydroxynaphthalene, 2,3-dihydroxynaphthalene and 1,6-dihydroxynaphthalene, or mixtures thereof. Preferably, the one or more bisphenol may be or comprise hydroquinone, 4,4′-dihydroxybenzophenone and 4,4′-dihydroxybiphenyl, or mixtures thereof.

The organic dihalide compound may be or comprise 4,4′-dichlorobenzophenone, 4-chloro-4′-fluorobenzophenone, 4,4′-difluorobenzophenone, 1,4-bis(4′-fluorobenzoyl)benzene and 1,3-bis(4′-fluorobenzoyl)benzene or mixtures thereof. Preferably the organic dihalide compound is 4,4′-difluorobenzophenone, 1,4-bis(4′-fluorobenzoyl)benzene or mixtures thereof. Most preferably the organic dihalide compound is 4,4′-difluorobenzophenone.

Step a of the process is preferably carried out under substantially anhydrous conditions. Step a is preferably carried out with stirring. The temperature may increase in step a at a rate of greater than 0.25° C./min, more preferably greater than 0.50° C./min, even more preferably greater than 0.70° C./min, but preferably less than 1.50° C./min, more preferably less than 1.25° C./min, even more preferably less than 1.10° C./min. Preferably, however, prior to reaching a maximum temperature, step a of the process may further comprise one or more periods of time during which the temperature is held to remain constant. For example, step a of the process may further comprise one or more periods of time (e.g. for at least 20 minutes) during which the temperature is constant, for instance at a temperature from 170° C. to 210° C.; and/or at a temperature from 210° C. to 240° C.

In step a of the process the bisphenol and the organic dihalide compound are preferably brought into contact with each other prior to contacting with the sodium and potassium carbonates, preferably in the presence of a solvent, preferably diphenylsulfone, prior to the contacting with the carbonates.

Preferably in step a, after the maximum temperature is reached, the maximum temperature is maintained until a desired molecular mass of the PAEK has been reached. The desired molecular mass may be indicated by reaching a desired stirrer torque rise. A relationship can be obtained between the molecular mass of the polymer in solution and the torque experienced by a stirrer motor. This is for a defined mass, polymer concentration and temperature. Based on this relationship, a torque rise can be predicted for a desired molecular mass (number average or weight average molecular mass).

The further organic dihalide compound added in step c may be selected from one or more of 4,4′-difluorobenzophenone or 4,4′-dichlorodiphenylsulfone, 1,3-Bis(4-fluorobenzoyl)benzene, 4,4′-dichlorobenzophenone, and 1,3-bis(4-chlorobenzoyl)benzene. The end-capping agent is preferably 4,4′-difluorobenzophenone. As a result of the addition in step c, ends of the PAEK may be end-capped with halogen atoms, preferably fluorine atoms, which is understood to stabilise the PAEK. The molar ratio of further organic dihalide compound to bisphenol is greater than 0.008 to less than 0.036, more preferably from 0.009 to 0.035, preferably less than 0.030 molar ratio, even more preferably less than 0.025 molar ratio, most preferably less than 0.022 molar ratio. A preferred addition of further organic dihalide composition is from 0.010 to 0.020 molar ratio, such as 0.012 to 0.018.

In particular, the process of the invention is suitable for the preparation of PAEK wherein the PAEK comprises a repeat unit of formula:

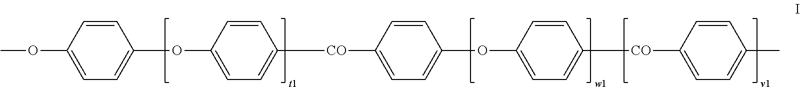

wherein t1 and w1 independently represent 0 or 1 and v1 represents 0, 1 or 2.

Preferred PAEKs have a the repeat unit wherein t1=1, v1=0 and w1=0; t1=0, v1=0 and w1=0; t1=0, w1=1, v1=2; or t1=0, v1=1 and w1=0. More preferred have a repeat unit wherein t1=1, v1=0 and w1−0; or t1=0, v1=0 and w1=0. The most preferred has a repeat unit wherein t1=1, v1=0 and w1=0.

In preferred embodiments, the PAEK is selected from polyetheretherketone, polyetherketone, polyetherketoneetherketoneketone and/or polyetherketoneketone, and/or a copolymer including polyetheretherketone and polyetherdiphenyletherketone. In a more preferred embodiment, the PAEK is selected from polyetherketone and/or polyetheretherketone, and/or a copolymer including polyetheretherketone and polyetherdiphenyletherketone. In an especially preferred embodiment, the PAEK is selected from polyetheretherketone, and/or a copolymer including polyetheretherketone and polyetherdiphenyletherketone.

The PAEK suitably includes at least 50 mol %, (e.g. 50-99.8 mol %), preferably at least 60 mol % (e.g. 60-100 mol %), more preferably at least 68 mol % (e.g. 68 to 100 mol %), of repeat units of formula I, especially such units where t1=1, v1=0 and w1=0. In an especially preferred embodiment, the PAEK includes at least 90 mol %, preferably at least 95 mol %, more preferably at least 98 mol %, especially at least 99 mol % of repeat units of formula I, especially repeat units of formula I wherein t1=1, v1=0 and w1=0. Other repeat units in the PAEK may be different repeat units of formula I or may include -Ph-Ph- moieties where Ph represents an unsubstituted phenylene moiety (especially wherein both -Ph- moieties are linked to each other and to adjacent repeat units at the 4,4′ positions-). Other repeat units may include Ph moieties bonded to two moieties selected from carbonyl moieties and ether moieties and -Ph-Ph- moieties bonded to two ether moieties.

The PAEK formed in the process may be a copolymer which comprises a first moiety of formula I and a second moiety which includes -Ph-Ph- moieties where Ph represents an unsubstituted phenylene moiety (which suitably includes 4,4′ bonds to adjacent moieties).

In one embodiment, the PAEK may be selected from: a polymer comprising at least 98 mol % of a repeat unit of formula I, especially such units wherein t1=1, v1=0 and w1=0; and a copolymer which includes a repeat unit of formula

—O-Ph-O-Ph-CO-Ph II

and a repeat unit of formula

—O-Ph-Ph-O-Ph-CO-Ph III

wherein Ph represents a phenylene moiety. Preferably the repeat units of the copolymer consist essentially of the repeat units II and III.

In a preferred embodiment, the PAEK is homopolymer polyetheretherketone, PEEK, with repeat units consisting of formula II:

—O-Ph-O-Ph-CO-Ph- II

or is a copolymer with repeat units consisting repeat units of formula II and repeat units of formula III:

—O-Ph-Ph-O-Ph-CO-Ph- III.

The ends of the polymer may be provided by the same monomers as the monomers making up the repeat units or may be provided by other compounds specifically added to provide end-capping.

Preferably the PAEK is homopolymer PEEK. More preferably, the ends of the polymer are provided by the same monomers as those used to form the repeat units.

The PAEK may preferably comprise at least 98 mole % (e.g. 98 to 99.9 mole %) of a repeat unit of formula I ora copolymer which includes repeat units of formulae II and III.

In the copolymer, the repeat units II and III are preferably in the relative molar proportions VI:VII of from 50:50 to 95:5, more preferably from 60:40 to 95:5, even more preferably from 65:35 to 95:5.

The phenylene moieties (Ph) in each repeat unit II and III may independently have 1,4-para linkages to atoms to which they are bonded or 1,3-meta linkages. Where a phenylene moiety includes 1,3-linkages, the moiety will be in the amorphous phase of the polymer. Crystalline phases will include phenylene moieties with 1,4-linkages. It is generally preferred for the PAEK or PEEK to be crystalline, for instance having a crystallinity of about 25 to 35% and, accordingly, the PAEK or PEEK preferably includes high levels of phenylene moieties with 1,4-linkages.

In a preferred embodiment, at least 95%, preferably at least 99%, of the number of phenylene moieties (Ph) in the repeat unit of formula II have 1,4-linkages to moieties to which they are bonded. It is especially preferred that each phenylene moiety in the repeat unit of formula II has 1,4-linkages to moieties to which it is bonded.

In a preferred embodiment, at least 95%, preferably at least 99%, of the number of phenylene moieties (Ph) in the repeat unit of formula III have 1,4-linkages to moieties to which they are bonded. It is especially preferred that each phenylene moiety in the repeat unit of formula III has 1,4-linkages to moieties to which it is bonded.

Preferably, the phenylene moieties in the repeat unit of formula II are unsubstituted. Preferably, the phenylene moieties in the repeat unit of formula III are unsubstituted.

The repeat unit of formula II preferably has the structure:

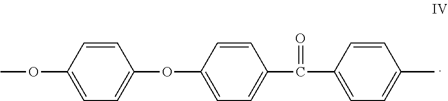

The repeat unit of formula III preferably has the structure:

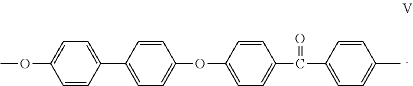

The copolymer may include at least 50 mol %, preferably at least 60 mol % of repeat units of formula IV. Particular advantageous copolymers may include at least 62 mol %, or, especially, at least 64 mol % of repeat units of formula IV. The copolymer may include less than 90 mol %, suitably 82 mol % or less of repeat units of formula IV. The copolymer may include 58 to 82 mol %, preferably 60 to 80 mol %, more preferably 62 to 77 mol % of units of formula IV.

The copolymer may include at least 10 mol %, preferably at least 18 mol %, of repeat units of formula V. The copolymer may include less than 42 mol %, preferably less than 39 mol % of repeat units of formula V. Particularly advantageous copolymers may include 38 mol % or less; or 36 mol % or less of repeat units of formula V. The copolymer may include 18 to 42 mol %, preferably 20 to 40 mol %, more preferably 23 to 38 mol % of units of formula V.

The sum of the mol % of units of formula IV and V in the copolymer is suitably at least 95 mol %, is preferably at least 98 mol %, is more preferably at least 99 mol %.

The skilled person would have no difficulty in selecting suitable monomer combinations for use in the process of the invention in order to arrive at the PAEKs described above. For instance, the bisphenol may be one or more of hydroquinone, 4,4′-dihydroxybenzophenone and 4,4′-dihydroxybiphenyl. The organic dihalide compound of step a may be 4,4′-difluorobenzophenone. The further organic dihalide compound of step c may also be 4,4′-difluorobenzophenone.

In a most preferred process according to the invention, the process is for the preparation of a polyetheretherketone PEEK polymer in which the polymer comprises at least 90 mol % of repeat units of formula II, preferably is a homopolymer consisting or consisting essentially of a polymer of repeat units of formula II with corresponding end groups from the monomers used to generate the repeat units. For this embodiment of the process, the bisphenol is preferably hydroquinone and the organic dihalide compound is preferably 4,4′-difluorobenzophenone, with diphenylsulfone as the solvent. The further organic dihalide compound added in step c is also preferably 4,4′-difluorobenzophenone.

Such polymers which comprise at least 90 mol % of repeat units of formula II, preferably consisting or consisting essentially of a polymer of repeat units of formula II with corresponding end groups from the monomers used to generate the repeat units, as referred to herein as PEEK polymers.

Hence, in a preferred embodiment of the process of the invention, there is provided a process for producing homopolymer polyetheretherketone (PEEK), the process comprising:

a nucleophilic polycondensation of hydroquinone with 4,4′-difluorobenzophenone in a reaction mixture comprising sodium carbonate and potassium carbonate, in an aromatic sulfone solvent, preferably diphenylsulfone, at a reaction temperature rising to a temperature from 290° C. to 320° C. immediately prior to;

b addition of a salt to the reaction mixture, wherein the molar ratio of the salt to potassium carbonate is from 6.0 to 10.0;

c addition of 4,4′-difluorobenzophenone to the reaction mixture, simultaneously with, or subsequent to, step b, wherein the molar ratio of 4,4′-difluorobenzophenone to hydroquinone is from 0.009 to 0.035;

d maintenance of the resulting reaction mixture's temperature at from 290° C. to 320° C. for from 20 to 180 minutes;

e cooling of the resulting reaction mixture and recovery of the PEEK resulting from steps a to d from the reaction mixture;

wherein in step a of the process:

i the molar ratio of sodium carbonate to hydroquinone is from 0.95 to 1.15;

ii the molar ratio of potassium carbonate to sodium carbonate is from 0.0025 to 0.0040; and

iii the molar ratio of 4,4′-difluorobenzophenone to hydroquinone is from 1.005 to 1.010.

The optional preferred features for this process for PEEK formation are as set out above in relation to the process for PAEK formation described above.

The salt may be an alkali metal salt or an alkaline earth metal salt. The salt may be selected from lithium chloride, calcium chloride, magnesium chloride, lithium bromide, lithium iodide and/or lithium sulphate. In one example, the salt is preferably lithium chloride. In another example the salt is preferably lithium sulphate. The molar equivalents of the salt (relative to the moles of potassium carbonate present in step a of the process) may be at least 1.0 molar equivalents, preferably at least 4.0 molar equivalents, more preferably at least 6.0 molar equivalents, most preferably at least 7.0 molar equivalents. The molar equivalents of the salt may be less than 15.0 molar equivalents, preferably less than 12.0 molar equivalents, more preferably less than 10.0 molar equivalents, most preferably less than 9.0 molar equivalents.

The molar ratio of potassium carbonate may alternatively be defined as the molar ratio of potassium carbonate to hydroquinone and may range from 0.0025 to 0.0046.

The process of the invention results in the formation of a PAEK or PEEK polymer comprising residual impurities of aromatic sulfone solvent, sodium salt and organic dihalide monomer from its formation by nucleophilic polycondensation. At the time of writing, it had not proved possible to remove all of these residual impurities when recovering PAEK or PEEK on an industrial scale from commercially viable reaction mixtures in which the PAEK or PEEK was formed by nucleophilic polycondensation. This is thought to be due to trapping of the residual impurities in the solidified PAEK or PEEK so that not all impurities are accessible for removal by solvent extraction.

When the process is specifically for making a PEEK polymer as described above, the PEEK polymer may comprise residual impurities of aromatic sulfone solvent, particularly diphenylsulfone, sodium salt and organic dihalide monomer, particularly 4,4′-difluourobenzophenone, from its formation by nucleophilic polycondensation.

However, it has been found that the process of the invention surprisingly results in greater ease of extraction of the residual impurities, particularly the residual impurities of aromatic sulfone solvent and organic dihalide monomer, so that the levels of these impurities may be reduced to previously unattainably low values. Without wishing to be bound by any theory, it is thought that the process of the invention leads to the formation of a PAEK or PEEK with unusually low levels of branching compared to PAEK or PEEK formed in prior art nucleophilic polycondensation processes.

For instance, a typical prior art PEEK prepared by nucleophilic polycondensation in DPS as solvent in the presence of sodium carbonate, with 4,4′-difluourobenzophenone as the organic dihalide monomer, will comprise at least at least 0.064 wt. % of DPS even after extensive solvent/water washing to extract reaction by-products. Furthermore, the PEEK may be prone to release residual 4,4′-difluourobenzophenone in certain environments such that the PEEK is not suitable for use in materials that come into contact with food, even after extensive solvent/water washing to extract reaction by-products.

Hence, according to an aspect of the present invention there is provided a polyaryletherketone (PAEK), wherein when the PAEK is dissolved in concentrated sulfuric acid, for instance having a concentration of 95-98% by weight sulfuric acid, specific gravity of 1.84 g/ml at 25° C., to prepare a resultant solution with 1 g of the PAEK per 100 ml of the resulting solution, the resultant solution has an absorbance from the PAEK of less than 0.20 at a wavelength of light of 550 nm.

The PAEK may comprise residual impurities of aromatic sulfone solvent, particularly diphenylsulfone, sodium salt and organic dihalide monomer from its formation by nucleophilic polycondensation.

In particular, the PAEK may be a PEEK polymer as described above. The PEEK polymer may comprise residual impurities of aromatic sulfone solvent, particularly diphenylsulfone, sodium salt and organic dihalide monomer, particularly 4,4′-difluorobenzophenone, from its formation by nucleophilic polycondensation.

Preferably the resultant solution may exhibit an absorbance from the dissolved PAEK of less than 0.18, more preferably less than 0.16, even more preferably less than 0.14, most preferably less than 0.12, at a wavelength of light of 550 nm. The resultant solution may exhibit an absorbance of greater than 0.02, such as greater than 0.04, for instance greater than 0.06, at a wavelength of light of 550 nm.

Without wishing to be bound by any theory, it is thought that the absorbance at 550 nm in the specified solution is an indicator of the presence of branching in the PAEK, so that low absorbance is thought to correspond to a low degree of branching in the PAEK.

It has surprisingly been found that the PAEK of the first aspect of the invention has enhanced mechanical properties, has light colour and has a lower incidence of gels compared to PAEK made by prior art nucleophilic condensation. It has also been found that such PAEKs, when treated by solvent washing to remove residual impurities from the nucleophilic condensation, can be purified to a greater extent than was achievable by solvent washing of prior art PAEKs, such that the residual levels of organic dihalide compounds and of aromatic sulfone polymerisation solvent, particularly of DPS when DPS is used as polymerisation solvent, are lower than was previously attainable.

The absorbance that a resultant solution, obtained by dissolving PAEK in concentrated sulfuric acid at the specified levels explained above, is thought to correspond to the level of carbonyl branching of the PAEK, i.e. branching that has occurred via reaction at a carbonyl carbon to form a branch point, e.g. a triaryl carbinol. Such branch points are converted to stable carbonium ions in the presence of sulfuric acid which gives rise to the absorbance of light at a wavelength of 550 nm exhibited by the resultant solutions of PAEKs comprising such branch points. The PAEK of the first aspect comprises lower levels of carbonyl branching than known PAEKs as indicated by the absorbance measurement.

The invention also provides a polyaryletherketone (PAEK), wherein the PAEK has a molecular mass dispersity, also referred to as a polydispersity index (PDI), of less than 2.6. The molecular mass dispersity, or polydispersity index, PDI, may suitably be measured in accordance with Example 4.

The PAEK with this molecular weight dispersity may comprise residual impurities of aromatic sulfone solvent, particularly diphenylsulfone, sodium salt and organic dihalide monomer from its formation by nucleophilic polycondensation.

In particular, the PAEK may be a PEEK polymer as described above. The PEEK polymer with the specified molecular mass dispersity may comprise residual impurities of aromatic sulfone solvent, particularly diphenylsulfone, sodium salt and organic dihalide monomer, particularly 4,4′-difluorobenzophenone, from its formation by nucleophilic polycondensation.

The molecular mass (also referred to as molecular weight) dispersity was formerly also referred to by the term “polydispersity index” or PDI, and corresponds to the value:

PDI=Mw/Mn

where Mw=weight average molecular mass and Mn=number average molecular mass.

PDI has a value equal to or greater than 1, with the value approaching 1 if all polymer chains in a sample are of uniform chain length.

For some addition polymerization, dispersity can be as high as 10 or more. However, for typical step growth polymerization of linear polymers carried out in batch reactors, most probable values of dispersity are around 2.6. Carothers' equation limits dispersity/PDI for linear polymers formed by step-growth from 2 monomers to minimum value of 2.

However, for branched polymers, the modified Carothers' equation leads to values in excess of 2, and in practice, for PAEKs formed by nucleophilic polycondensation, typical value considerably in excess of 2 are found in the prior art, indicating that conventional nucleophilic polycondensation leads to branching of the PAEK or PEEK formed.

Surprisingly, the process of the present invention has been found to generate PAEK polymers with low degrees of branching in which the molecular mass dispersity (PDI) approaches the minimum theoretical value of 2 for the polymer generated by the process.

The PAEK may have a PDI of less than 2.6, preferably less than 2.5, more preferably less than 2.4, even more preferably less than 2.3, most preferably less than 2.2.

The PAEK has a PDI of 2.0 or more.

The PAEK of low PDI may comprise residual impurities of aromatic sulfone solvent, particularly diphenylsulfone, sodium salt and organic dihalide monomer from its formation by nucleophilic polycondensation.

In particular, the PAEK may be a PEEK polymer as described above. The PEEK polymer of low PDI may comprise residual impurities of aromatic sulfone solvent, particularly diphenylsulfone, sodium salt and organic dihalide monomer, particularly 4,4′-difluorobenzophenone, from its formation by nucleophilic polycondensation.

The invention also provides a PEEK, wherein the PEEK comprises an extractable concentration of 0.05 mg/kg or less of 4,4′-difluorobenzophenone, for instance 0.04 mg/kg or less when the PEEK is submersed in a fatty food simulant at 175° C. for six hours. The level of 4,4′-difluorobenzophenone is expressed as the amount of extractable 4,4′-difluorobenzophenone per kg of PEEK including the 4,4′-difluorobenzophenone when the PEEK is submersed in a fatty food simulant at 175° C. for six hours. The level of extractable 4,4′-difluorobenzophenone in the PEEK may be measured by extraction into Miglyol 812. As such, the PEEK of the present invention is suitable for use with materials that come into contact with food. Details of the measurement of the level of the extractable 4,4′-difluorobenzophenone in the PEEK are as set out in the Example below.

Hence, the invention further provides the use of a PAEK or PEEK according to the invention in a component intended to contact food. The invention also provides components machined, formed, or moulded from, or coated with, a composition comprising or consisting of the PAEK or PEEK of the invention intended to contact food. The composition may comprise from 30 to 100% of the PAEK or PEEK of the invention with from 0 to 70% by weight of other components such as filler, for instance fibrous filler, colourants and the like. Preferably the composition comprises no other PAEK or PEEK, more preferably no other polymer.

In particular, the PEEK may be a PEEK polymer as described above and may comprise residual impurities of aromatic sulfone solvent, particularly diphenylsulfone, sodium salt and 4,4′-difluorobenzophenone, from its formation by nucleophilic polycondensation. In particular, the PEEK may be a PEEK formed by nucleophilic polycondensation from hydroquinone and 4,4′-difluorobenzophenone in DPS as a polymerisation solvent. The PEEK may be a PEEK formed in a process according to the invention.

The invention also provides a PAEK, wherein the PAEK comprises residual diphenylsulfone (DPS) present as 0.063% or less by weight (expressed as weight percent of the PAEK including the DPS). More preferably, the DPS is present as 0.060% by weight or less. The DPS may be 0.055% by weight or less, for instance, 0.052% by weight or less. However, there will typically be at least 0.01% by weight of DPS present.

The level of DPS in the PAEK may be measured by a test method as set out in the Example below.

In particular, the PAEK may be a PAEK polymer as described above and may comprise residual impurities of diphenylsulfone, sodium salt and organic dihalide monomer, such as 4,4′-difluorobenzophenone, from its formation by nucleophilic polycondensation in DPS as the aromatic sulfone polymerisation solvent.

In particular, the PAEK may be a PEEK polymer as described above and may comprise residual impurities of diphenylsulfone, sodium salt and 4,4′-difluorobenzophenone, from its formation by nucleophilic polycondensation in diphenylsulfone as aromatic sulfone polymerisation solvent. In particular, the PEEK may be a PEEK formed by nucleophilic polycondensation from hydroquinone and 4,4′-difluorobenzophenone in DPS as a polymerisation solvent. The PEEK may be formed in a process according to the invention.

The invention also provides polyaryletherketone (PAEK), wherein when the polymeric material is in the form of melt-filtered granules having a maximum dimension from 1 to 10 mm, preferably from 2 to 5 mm, the PAEK has a lightness L* of greater than 56.0, an a* coordinate of greater than 1.3 but less than 5.0, and a b* coordinate of greater than 6.5 but less than 10.0 with reference to the 1976 CIE L* a* b* colour space.

The PAEK of light colour may comprise residual impurities of aromatic sulfone solvent, particularly diphenylsulfone, sodium salt and organic dihalide monomer from its formation by nucleophilic polycondensation.

In particular, the PAEK may be a PEEK polymer as described above. The PEEK polymer of light colour may comprise residual impurities of aromatic sulfone solvent, particularly diphenylsulfone, sodium salt and organic dihalide monomer, particularly 4,4′-difluorobenzophenone, from its formation by nucleophilic polycondensation.

It has surprisingly been found that the PAEK or PEEK of the present invention is lighter and consequently appears whiter than known PAEKs or PEEKs. As detailed above, lighter/whiter PAEKs and PEEKs are useful because they enable ease of colour matching with similarly coloured components and their colour can be more easily adjusted.

Preferably the PAEK or PEEK in the form of melt-filtered granules having a maximum dimension from 1 to 10 mm has a lightness L* of greater than 58.0, more preferably greater than 59.0, even more preferably greater than 60.0, most preferably greater than 61.0.

Preferably the PAEK or PEEK in the form of melt-filtered granules having a maximum dimension from 1 to 10 mm has an a* coordinate of greater than 1.5 but less than 3.5, more preferably greater than 1.8 but less than 3.0, even more preferably greater than 2.0 but less than 2.5, most preferably greater than 2.1 but less than 2.4.

Preferably the PAEK in the form of melt-filtered granules having a maximum dimension from 1 to 10 mm has a b* coordinate of greater than 6.7 but less than 9.0, more preferably greater than 7.0 but less than 8.7, even more preferably greater than 7.2 but less than 8.5, most preferably greater than 7.4 but less than 8.4.

In a preferred embodiment the PAEK or PEEK in the form of melt-filtered granules having a maximum dimension from 1 to 5 mm has a lightness L* of greater than 60.0, an a* coordinate of greater than 2.0 but less than 2.5, and a b* coordinate of greater than 7.2 but less than 8.5. In a more preferred embodiment the PAEK or PEEK has a lightness L* of greater than 61.0, an a* coordinate of greater than 2.1 but less than 2.4, and a b* coordinate of greater than 7.4 but less than 8.4.

The invention also provides a device or article formed, moulded, machined from, or coated with, a composition comprising or consisting of a PAEK or a homopolymer PEEK according to the invention. The composition may consist of the PAEK or PEEK of the invention, or may include say 30 to 100% by weight of the PAEK or PEEK, with from 0 to 70% by weight of other ingredients, for instance filler, such as fibrous filler, colourants and the like. Preferably no other PAEK and more preferably no other polymer is present in the composition

The PAEK of the device or article may comprise residual impurities of aromatic sulfone solvent, particularly diphenylsulfone, sodium salt and organic dihalide monomer from its formation by nucleophilic polycondensation.

In particular, the PAEK may be a PEEK polymer as described above. The PEEK polymer of the formed, moulded or machined device or article may comprise residual impurities of aromatic sulfone solvent, particularly diphenylsulfone, sodium salt and organic dihalide monomer, particularly 4,4′-difluorobenzophenone, from its formation by nucleophilic polycondensation.

The PAEK of the invention, when injection moulded, for instance as a disc, tablet, plaque or other form of sample, to provide planar surface from a powder of the PAEK, may have a lightness L* of greater than 65.0, an a* coordinate of greater than 0.2 but less than 5.0, and a b* coordinate of greater than 5.0 but less than 12.0, with reference to the 1976 CIE L* a* b* colour space. The method of colour measurement may suitably be as set out in Example 6.

The PAEK in planar surface form may comprise residual impurities of aromatic sulfone solvent, particularly diphenylsulfone, sodium salt and organic dihalide monomer from its formation by nucleophilic polycondensation.

In particular, the PAEK may be a PEEK polymer as described above. The PEEK in planar surface form may comprise residual impurities of aromatic sulfone solvent, particularly diphenylsulfone, sodium salt and organic dihalide monomer, particularly 4,4′-difluorobenzophenone, from its formation by nucleophilic polycondensation.

Preferably the PAEK or PEEK in planar surface form has a lightness L* of greater than 67.0, more preferably greater than 69.0, even more preferably greater than 70.0, most preferably greater than 71.0.

Preferably the PAEK or PEEK in planar surface form has an a* coordinate of greater than 0.5 but less than 4.5, more preferably greater than 0.8 but less than 4.0, even more preferably greater than 1.0 but less than 3.5, most preferably greater than 1.1 but less than 3.2.

Preferably the PAEK or PEEK in planar surface form has a b* coordinate of greater than 5.5 but less than 11.0, more preferably greater than 6.0 but less than 10.5, even more preferably greater than 6.5 but less than 10.0, most preferably greater than 7.0 but less than 9.7.

In a preferred embodiment the PAEK or PEEK in planar surface form has a lightness L* of greater than 70.0, an a* coordinate of greater than 1.0 but less than 3.5, and a b* coordinate of greater than 6.5 but less than 10.0. In a more preferred embodiment the PAEK or PEEK in planar surface form has a lightness L* of greater than 71.0, an a* coordinate of greater than 1.1 but less than 3.2, and a b* coordinate of greater than 7.0 but less than 9.7.

Preferably the PAEK of the invention comprises a repeat unit of formula:

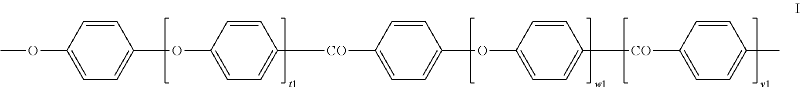

wherein t1 and w1 independently represent 0 or 1 and v1 represents 0, 1 or 2.

Preferred PAEKs have a the repeat unit wherein t1=1, v1=0 and w1=0; t1=0, v1=0 and w1=0; t1=0, w1=1, v1=2; or t1=0, v1=1 and w1=0. More preferred have a repeat unit wherein t1=1, v1=0 and w1−0; or t1=0, v1=0 and w1=0. The most preferred has a repeat unit wherein t1=1, v1=0 and w1=0.

In preferred embodiments, the PAEK is selected from polyetheretherketone, polyetherketone, polyetherketoneetherketoneketone and/or polyetherketoneketone, and/or a copolymer including polyetheretherketone and polyetherdiphenyletherketone. In a more preferred embodiment, the PAEK is selected from polyetherketone and/or polyetheretherketone, and/or a copolymer including polyetheretherketone and polyetherdiphenyletherketone. In an especially preferred embodiment, the PAEK is selected from polyetheretherketone, and/or a copolymer including polyetheretherketone and polyetherdiphenyletherketone.

The PAEK suitably includes at least 50 mol %, (e.g. 50-99.8 mol %), preferably at least 60 mol % (e.g. 60-100 mol %), more preferably at least 68 mol % (e.g. 68 to 100 mol %), of repeat units of formula I, especially such units where t1=1, v1=0 and w1=0. In an especially preferred embodiment, the PAEK includes at least 90 mol %, preferably at least 95 mol %, more preferably at least 98 mol %, especially at least 99 mol % of repeat units of formula I, especially repeat units of formula I wherein t1=1, v1=0 and w1=0. Other repeat units in the PAEK may be of formula I; or may include -Ph-Ph- moieties where Ph suitably represents an unsubstituted phenylene moiety (especially wherein both -Ph- moieties are 4,4′-substituted). Other repeat units may include Ph moieties bonded to two moieties selected from carbonyl moieties and ether moieties; and -Ph-Ph- moieties bonded to two ether moieties.

The PAEK may be a copolymer which comprises a first moiety of formula I and a second moiety which includes -Ph-Ph- moieties where Ph represents an unsubstituted phenylene moiety (which suitably includes 4,4′-bonds to adjacent moieties).

In one embodiment, the PAEK may be selected from: a polymer comprising at least 98 mol % of a repeat unit of formula I, especially such units wherein t1=1, v1=0 and w1=0; and a copolymer which includes a repeat unit of formula

—O-Ph-O-Ph-CO-Ph- II

and a repeat unit of formula

—O-Ph-Ph-O-Ph-CO-Ph III

wherein Ph represents a phenylene moiety.

The PAEK preferably comprises at least 98 mol % (e.g. 98 to 99.9 mol %) of a repeat unit of formula I ora copolymer which includes repeat units of formulae II and III.

In a preferred embodiment, the PAEK is homopolymer polyetheretherketone, PEEK, with repeat units consisting of formula II:

—O-Ph-O-Ph-CO-Ph- II

or is a copolymer with repeat units consisting repeat units of formula II and repeat units of formula III:

—O-Ph-Ph-O-Ph-CO-Ph- III.

The ends of the polymer may be provided by the same monomers as the monomers making up the repeat units or may be provided by other compounds specifically added to provide end-capping.

Preferably the PAEK is homopolymer PEEK. More preferably, the ends of the polymer are provided by the same monomers as those used to form the repeat units

In the copolymer, the repeat units II and III are preferably in the relative molar proportions VI:VII of from 50:50 to 95:5, more preferably from 60:40 to 95:5, even more preferably from 65:35 to 95:5.

The phenylene moieties (Ph) in each repeat unit II and III may independently have 1,4-para linkages to atoms to which they are bonded or 1,3-meta linkages. Where a phenylene moiety includes 1,3-linkages, the moiety will be in the amorphous phase of the polymer. Crystalline phases will include phenylene moieties with 1,4-linkages. It is generally preferred for the PAEK to be highly crystalline and, accordingly, the PAEK preferably includes high levels of phenylene moieties with 1,4-linkages.

In a preferred embodiment, at least 95%, preferably at least 99%, of the number of phenylene moieties (Ph) in the repeat unit of formula II have 1,4-linkages to moieties to which they are bonded. It is especially preferred that each phenylene moiety in the repeat unit of formula II has 1,4-linkages to moieties to which it is bonded.

In a preferred embodiment, at least 95%, preferably at least 99%, of the number of phenylene moieties (Ph) in the repeat unit of formula III have 1,4-linkages to moieties to which they are bonded. It is especially preferred that each phenylene moiety in the repeat unit of formula III has 1,4-linkages to moieties to which it is bonded.

Preferably, the phenylene moieties in the repeat unit of formula II are unsubstituted. Preferably, the phenylene moieties in the repeat unit of formula III are unsubstituted.

The repeat unit of formula II suitably has the structure:

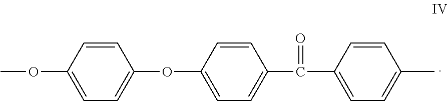

The repeat unit of formula III suitably has the structure:

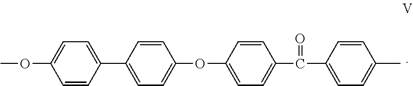

The copolymer may include at least 50 mol %, preferably at least 60 mol % of repeat units of formula IV. Particular advantageous copolymers may include at least 62 mol %, or, especially, at least 64 mol % of repeat units of formula IV. The copolymer may include less than 90 mol %, suitably 82 mol % or less of repeat units of formula IV. The copolymer may include 58 to 82 mol %, preferably 60 to 80 mol %, more preferably 62 to 77 mol % of units of formula IV.

The copolymer may include at least 10 mol %, preferably at least 18 mol %, of repeat units of formula V. The copolymer may include less than 42 mol %, preferably less than 39 mol % of repeat units of formula V. Particularly advantageous copolymers may include 38 mol % or less; or 36 mol % or less of repeat units of formula V. The copolymer may include 18 to 42 mol %, preferably 20 to 40 mol %, more preferably 23 to 38 mol % of units of formula V.

The sum of the mol % of units of formula IV and V in the copolymer is suitably at least 95 mol %, is preferably at least 98 mol %, is more preferably at least 99 mol %.

In a most preferred embodiment, the PAEK of the invention is a poly(etheretherketone) PEEK polymer in which the polymer comprises at least 90 mol % of repeat units of formula II, preferably consisting or consisting essentially of a polymer of repeat units of formula II with corresponding end groups from the monomers used to generate the repeat units. For this embodiment of the process, the bisphenol used in the nucleophilic polycondensation process for preparing the PEEK is preferably hydroquinone and the organic dihalide compound is preferably 4,4′-difluorobenzophenone, with diphenylsulfone as the solvent. The further organic dihalide compound added in step c is also preferably 4,4′-difluorobenzophenone, so that the PEEK may be at least partially end-capped with 4,4′-difluorobenzophenone.

Such polymers which comprise at least 90 mol % of repeat units of formula II, preferably consisting or consisting essentially of a polymer of repeat units of formula II with corresponding end groups from the monomers used to generate the repeat units, as referred to herein as PEEK polymers.

The PAEK polymer of the invention may comprise residual impurities of aromatic sulfone solvent, sodium salt and organic dihalide monomer from its formation by nucleophilic polycondensation. In particular, when the PAEK is a PEEK polymer as set out above, the PEEK polymer may comprise residual impurities of aromatic sulfone solvent, particularly diphenylsulfone, sodium salt and organic dihalide monomer, particularly 4,4′-difluorobenzophenone, from its formation by nucleophilic polycondensation.

The PAEK or PEEK may be in a particulate form such as a powder, pellets or granules. The powder may have a maximum dimension as measured by sieving of less than 4.0 mm, preferably less than 3.0 mm, more preferably less than 2.5 mm, but preferably of greater than 0.01 mm, more preferably of greater than 0.1 mm. The pellets or granules may have a maximum dimension of less than 10 mm, preferably less than 7.5 mm, more preferably less than 5.0 mm. The granule maximum dimension may be greater than 1.0 mm, for instance greater than 2.0 mm. The maximum dimension may suitably be assessed by sieving, so that the values referred to above may be determined according whether the granules pass though or are retained on a sieve of the maximum dimension referred to. The pellets or granules may have an aspect ratio of (maximum dimension):(minimum dimension) of 5:1 to 1:1, preferably 4:1 to 1:1, more preferably 3:1 to 1.1:1, even more preferably 2:1 to 1.1:1.

The PAEK or PEEK may be in a form such as a filament.

Preferably PAEK or PEEK has a critical strain energy release rate (as tested in accordance with Example 5) of at least 17.5 Jm⁻², preferably at least 17.8 Jm⁻², more preferably at least 18.0 Jm⁻².

Preferably PAEK or PEEK has a stress intensity factor K_{1C} (as tested in accordance with Example 5) of at least 5.000 MPa·√m, more preferably of at least or more than 5.050 MPa·√m.

The PAEK or PEEK preferably has a melt viscosity (MV) measured at 400° C. of at least 0.05 kNsm⁻², preferably has a MV of at least 0.10 kNsm⁻², more preferably at least 0.15 kNsm⁻². The PAEK or PEEK may have a MV of less than 1.20 kNsm⁻², suitably less than 1.00 kNsm⁻². The MV is measured using capillary rheometry operating at 400° C. at a shear rate of 1000 s⁻¹ using a circular cross-section tungsten carbide die, 0.5 mm (capillary diameter)×3.175 mm (capillary length). The MV measurement is taken once the polymer has fully melted, which is taken to be 5 minutes after the polymer is loaded into the barrel of the rheometer.

In some embodiments, the PAEK or PEEK may be compounded with one or more filler. The filler may include a fibrous filler or a non-fibrous filler. The filler may include both a fibrous filler and a non-fibrous filler. The fibrous filler may be continuous or discontinuous.

The fibrous filler may be selected from inorganic fibrous materials, non-melting and high-melting organic fibrous materials, such as aramid fibres, and carbon fibre.

The fibrous filler may be selected from glass fibre, carbon fibre, asbestos fibre, silica fibre, alumina fibre, zirconia fibre, boron nitride fibre, silicon nitride fibre, boron fibre, fluorocarbon resin fibre and potassium titanate fibre. Preferred fibrous fillers are glass fibre and carbon fibre. A fibrous filler may comprise nanofibers.

The non-fibrous filler may be selected from mica, silica, talc, hydroxyapatite (or hydroxylapatite), alumina, kaolin, calcium sulfate, calcium carbonate, titanium oxide, titanium dioxide, zinc sulfide, ferrite, clay, glass powder, zinc oxide, nickel carbonate, iron oxide, quartz powder, magnesium carbonate, fluorocarbon resin, graphite (including graphite nanoplatelets and graphene), carbon black, carbon powder, nanotubes (e.g. carbon nanotubes) and/or barium sulfate. The non-fibrous fillers may be introduced in the form of powder or flaky particles.

Preferably, the filler comprises or is one or more fillers selected from glass fibre, carbon fibre, aramid fibres, carbon black and a fluorocarbon resin. More preferably, the filler comprises or is glass fibre or carbon fibre. Such filler preferably comprises or is glass fibre.

A filled PAEK or PEEK composition as described may include at least 20 wt %, or at least 40 wt % of filler. The filled PAEK or PEEK may include 70 wt % or less or 60 wt % or less of filler.

The invention also provides an article which comprises, consists essentially of, or consists of a PAEK or PEEK according to the invention or made by the process of the invention. The article may be a film, a stock shape such as a rod, or a machined article. The article may be an injection moulded article, a compression moulded article or an extruded article. The article may be formed using an additive manufacturing technique.

The invention also provides a method for manufacturing a three-dimensional object from a PAEK or PEEK by additive layer manufacturing, wherein the PAEK or PEEK comprises, consists of essentially, or consists of PAEK or PEEK according to the invention or made by the process of the invention.

Additive layer manufacturing techniques include any one or more of filament fusion, laser sintering, powder bed fusion, ThermoMELT™ and micro pellet fusion.

The invention also provides a method for manufacturing a three-dimensional object from a powder by selective sintering by means of electromagnetic radiation, wherein the powder comprises, consists of essentially, or consists or PAEK or PEEK according to the invention or made by the process of the invention.

The invention also provides a film or tape formed of a composition comprising or consisting of PAEK according to the invention or made by the process of the invention. The film may be extruded and may have a thickness from 5 μm to 100 μm or preferably from 5 μm to 50 μm.

The PAEK or PEEK when as a film may have a gel/black speck level of less than 300 ppm, preferably less than 250 ppm, more preferably less than 200 ppm, even more preferably less than 180 ppm, when measured in accordance with Example 7.

The present invention also provides a pack comprising the PAEK or PEEK of the invention, preferably in the form of powder, pellets and/or granules.

The pack may include at least 1 kg, suitably at least 5 kg, preferably at least 10 kg, more preferably at least 14 kg of material of the polymeric material. The pack may include 1000 kg or less, preferably 500 kg or less of the polymeric material. Preferred packs include 10 to 500 kg of the polymeric material.

The pack may comprise packaging material (which is intended to be discarded or re-used) and a desired material (which suitably comprises the polymeric material). The packaging material preferably substantially fully encloses the desired material. The packaging material may comprise a first receptacle, for example a flexible receptacle such as a plastics bag in which the desired material is arranged. The first receptacle may be contained within a second receptacle for example in a box such as a cardboard box.

The invention also provides a pipe or sheath formed from a composition comprising or consisting of PAEK or PEEK according to the invention or made by the process of the invention.

The invention also provides a method for forming a pipe or sheath by extrusion of a composition comprising or consisting of PAEK according to the invention or made by the process of the invention.

According to a further aspect there is provided a polymeric material comprising a polyaryletherketone (PAEK),

wherein when said PAEK is dissolved in 1% w/v aqueous sulphuric acid to prepare a resultant solution, said resultant solution exhibits an absorbance of less than 0.20 at a wavelength of light of 550 nm, wherein said preparation of said resultant solution and measurement of its absorbance are carried out in accordance with Example 3.

It has surprisingly been found that the polymeric material has enhanced mechanical properties, colour characteristics and has a lower frequency of gels in comparison with known PAEKs.

The absorbance that a resultant solution, obtained by dissolving PAEK in sulphuric acid, exhibits at a wavelength of light of 550 nm when measured in accordance with Example 3 is thought to correspond to the level of carbonyl branching of said PAEK i.e. branching that has occurred via reaction at a carbonyl carbon to form a branch point e.g. a triaryl carbinol. During Example 3 these branch points are converted to stable carbonium ions in the presence of sulphuric acid which gives rise to the absorbance at 550 nm exhibited by resultant solutions of PAEKs with such branch points. The inventive polymeric material of the first aspect unexpectedly is thought to comprise lower levels of carbonyl branching than known polymeric materials.

Preferably said resultant solution exhibits an absorbance of less than 0.18, more preferably less than 0.16, even more preferably less than 0.14, most preferably less than 0.12, at a wavelength of light of 550 nm when measured in accordance with Example 3. Said resultant solution may exhibit an absorbance of greater than 0.02, preferably greater than 0.04, more preferably greater than 0.06, at a wavelength of light of 550 nm when measured in accordance with Example 3.

In the following discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

References herein such as “in the range x to y” are meant to include the interpretation “from x to y” and so include the values x and y.

The following features are generally applicable to the present invention:

Preferably said PAEK comprises a repeat unit of formula:

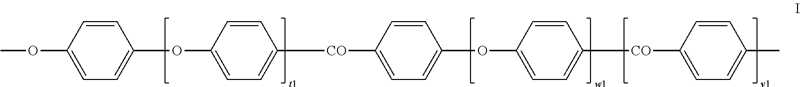

wherein t1 and w1 independently represent 0 or 1 and v1 represents 0, 1 or 2.

Preferred PAEKs have a said repeat unit wherein t1=1, v1=0 and w1=0; t1=0, v1=0 and w1=0; t1=0, w1=1, v1=2; or t1=0, v1=1 and w1=0. More preferred have a repeat unit wherein t1=1, v1=0 and w1−0; or t1=0, v1=0 and w1=0. The most preferred has a repeat unit wherein t1=1, v1=0 and w1=0.

In preferred embodiments, said PAEK is selected from polyetheretherketone, polyetherketone, polyetherketoneetherketoneketone and/or polyetherketoneketone, and/or a copolymer including polyetheretherketone and polyetherdiphenyletherketone. In a more preferred embodiment, said PAEK is selected from polyetherketone and/or polyetheretherketone, and/or a copolymer including polyetheretherketone and polyetherdiphenyletherketone. In an especially preferred embodiment, said PAEK is selected from polyetheretherketone, and/or a copolymer including polyetheretherketone and polyetherdiphenyletherketone.

Said PAEK suitably includes at least 50 mol %, (e.g. 50-99.8 mol %), preferably at least 60 mol % (e.g. 60-100 mol %), more preferably at least 68 mol % (e.g. 68 to 100 mol %), of repeat units of formula I, especially such units where t1=1, v1=0 and w1=0. In an especially preferred embodiment, said PAEK includes at least 90 mol %, preferably at least 95 mol %, more preferably at least 98 mol %, especially at least 99 mol % of repeat units of formula I, especially repeat units of formula I wherein t1=1, v1=0 and w1=0. Other repeat units in said PAEK may be of formula I; or may include -Ph-Ph- moieties where Ph suitably represents an unsubstituted phenylene moiety (especially wherein both -Ph- moieties are 4,4′-substituted). Other repeat units may include Ph moieties bonded to two moieties selected from carbonyl moieties and ether moieties; and -Ph-Ph- moieties bonded to two ether moieties.

Said PAEK suitably includes at least 50 wt % (e.g. 50-100 wt %) of repeat units of formula I.

Said PAEK may be a copolymer which comprises a first moiety of formula I and a second moiety which includes -Ph-Ph- moieties where Ph represents an unsubstituted phenylene moiety (which suitably includes 4,4′-bonds to adjacent moieties).

In one embodiment, said PAEK may be selected from: a polymer comprising at least 98 mol % and/or comprising at least 98 wt % of a repeat unit of formula I, especially such units wherein t1=1, v1=0 and w1=0; and a copolymer which includes a repeat unit of formula

—O-Ph-O-Ph-CO-Ph II

and a repeat unit of formula

—O-Ph-Ph-O-Ph-CO-Ph III

wherein Ph represents a phenylene moiety.

Said PAEK preferably comprises at least 98 wt % (e.g. 98 to 99.9 wt %) of a repeat unit of formula I or a copolymer which includes repeat units of formulae II and III.

In said copolymer, said repeat units II and III are preferably in the relative molar proportions

VI:VII of from 50:50 to 95:5, more preferably from 60:40 to 95:5, even more preferably from 65:35 to 95:5.

The phenylene moieties (Ph) in each repeat unit II and III may independently have 1,4-para linkages to atoms to which they are bonded or 1,3-meta linkages. Where a phenylene moiety includes 1,3-linkages, the moiety will be in the amorphous phase of the polymer. Crystalline phases will include phenylene moieties with 1,4-linkages. It is generally preferred for the PAEK to be highly crystalline and, accordingly, the PAEK preferably includes high levels of phenylene moieties with 1,4-linkages.

In a preferred embodiment, at least 95%, preferably at least 99%, of the number of phenylene moieties (Ph) in the repeat unit of formula II have 1,4-linkages to moieties to which they are bonded. It is especially preferred that each phenylene moiety in the repeat unit of formula II has 1,4-linkages to moieties to which it is bonded.

In a preferred embodiment, at least 95%, preferably at least 99%, of the number of phenylene moieties (Ph) in the repeat unit of formula III have 1,4-linkages to moieties to which they are bonded. It is especially preferred that each phenylene moiety in the repeat unit of formula III has 1,4-linkages to moieties to which it is bonded.

Preferably, the phenylene moieties in the repeat unit of formula II are unsubstituted. Preferably, the phenylene moieties in the repeat unit of formula III are unsubstituted.

Said repeat unit of formula II suitably has the structure:

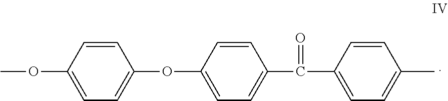

Said repeat unit of formula III suitably has the structure:

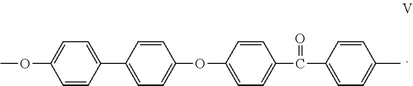

Said copolymer may include at least 50 mol %, preferably at least 60 mol % of repeat units of formula IV. Particular advantageous copolymers may include at least 62 mol %, or, especially, at least 64 mol % of repeat units of formula IV. Said copolymer may include less than 90 mol %, suitably 82 mol % or less of repeat units of formula IV. Said copolymer may include 58 to 82 mol %, preferably 60 to 80 mol %, more preferably 62 to 77 mol % of units of formula IV.

Said copolymer may include at least 10 mol %, preferably at least 18 mol %, of repeat units of formula V. Said copolymer may include less than 42 mol %, preferably less than 39 mol % of repeat units of formula V. Particularly advantageous copolymers may include 38 mol % or less; or 36 mol % or less of repeat units of formula V. Said copolymer may include 18 to 42 mol %, preferably 20 to 40 mol %, more preferably 23 to 38 mol % of units of formula V.

The sum of the mol % of units of formula IV and V in said copolymer is suitably at least 95 mol %, is preferably at least 98 mol %, is more preferably at least 99 mol %.

Said polymeric material may be in a particulate form such as a powder, pellets or granules. Said powder may have a maximum dimension of less than 4.0 mm, preferably less than 3.0 mm, more preferably less than 2.5 mm, but preferably of greater than 0.01 mm, more preferably of greater than 0.1 mm. Said pellets or granules may have a maximum dimension of less than 10 mm, preferably less than 7.5 mm, more preferably less than 5.0 mm. Said pellets or granules may have an aspect ratio of maximum dimension:minimum dimension of 5:1 to 1:1, preferably 4:1 to 1:1, more preferably 3:1 to 1.1:1, even more preferably 2:1 to 1.1:1. Said powder, pellets or granules may include at least 95wt %, preferably at least 99wt %, especially about 100wt % of said polymeric material.

Preferably said polymeric material has a critical strain energy release rate (as tested in accordance with example 5) of at least 17.5 Jm⁻², preferably at least 17.8 Jm⁻², more preferably at least 18.0 KJm⁻².

Said polymeric material preferably has a melt viscosity (MV) measured at 400° C. of at least 0.05 kNsm⁻², preferably has a MV of at least 0.10 kNsm⁻², more preferably at least 0.15 kNsm⁻². Said polymeric material may have a MV of less than 1.20 kNsm⁻², suitably less than 1.00 kNsm⁻². The MV is measured using capillary rheometry operating at 400° C. at a shear rate of 1000 s⁻¹ using a circular cross-section tungsten carbide die, 0.5 mm (capillary diameter)×3.175 mm (capillary length). The MV measurement is taken once the polymer has fully melted, which is taken to be 5 minutes after the polymer is loaded into the barrel of the rheometer.

In some embodiments, said polymeric material may further comprise one or more filler. Said filler may include a fibrous filler or a non-fibrous filler. Said filler may include both a fibrous filler and a non-fibrous filler. A said fibrous filler may be continuous or discontinuous.

A said fibrous filler may be selected from inorganic fibrous materials, non-melting and high-melting organic fibrous materials, such as aramid fibres, and carbon fibre.

A said fibrous filler may be selected from glass fibre, carbon fibre, asbestos fibre, silica fibre, alumina fibre, zirconia fibre, boron nitride fibre, silicon nitride fibre, boron fibre, fluorocarbon resin fibre and potassium titanate fibre. Preferred fibrous fillers are glass fibre and carbon fibre. A fibrous filler may comprise nanofibers.

A said non-fibrous filler may be selected from mica, silica, talc, hydroxyapatite (or hydroxylapatite), alumina, kaolin, calcium sulfate, calcium carbonate, titanium oxide, titanium dioxide, zinc sulphide, ferrite, clay, glass powder, zinc oxide, nickel carbonate, iron oxide, quartz powder, magnesium carbonate, fluorocarbon resin, graphite, carbon black, carbon powder, nanotubes (e.g. carbon nanotubes) and/or barium sulphate. The non-fibrous fillers may be introduced in the form of powder or flaky particles.

Preferably, said filler comprises one or more fillers selected from glass fibre, carbon fibre, aramid fibres, carbon black and a fluorocarbon resin. More preferably, said filler comprises glass fibre or carbon fibre. Such filler preferably comprises glass fibre.

The polymeric material as described may include at least 20 wt %, or at least 40 wt % of filler. Said polymeric material may include 70 wt % or less or 60 wt % or less of filler.

The PAEK of the polymeric material may have a polydispersity index (PDI) of less than 2.6, when measured in accordance with Example 4. Preferably said PAEK has a polydispersity index (PDI) of less than 2.5, more preferably less than 2.4, even more preferably less than 2.3, most preferably less than 2.2, when measured in accordance with Example 4.

The polymeric material, wherein said polymeric material is in the form of melt-filtered granules, may have a lightness L* of greater than 56.0, an a* coordinate of greater than 1.3 but less than 5.0, and a b* coordinate of greater than 6.5 but less than 10.0. Preferably said polymeric material has a lightness L* of greater than 58.0, more preferably greater than 59.0, even more preferably greater than 60.0, most preferably greater than 61.0. Preferably said polymeric material has an a* coordinate of greater than 1.5 but less than 3.5, more preferably greater than 1.8 but less than 3.0, even more preferably greater than 2.0 but less than 2.5, most preferably greater than 2.1 but less than 2.4. Preferably said polymeric material has a b* coordinate of greater than 6.7 but less than 9.0, more preferably greater than 7.0 but less than 8.7, even more preferably greater than 7.2 but less than 8.5, most preferably greater than 7.4 but less than 8.4. In a preferred embodiment said polymeric material has a lightness L* of greater than 60.0, an a* coordinate of greater than 2.0 but less than 2.5, and a b* coordinate of greater than 7.2 but less than 8.5. In a more preferred embodiment said polymeric material has a lightness L* of greater than 61.0, an a* coordinate of greater than 2.1 but less than 2.4, and a b* coordinate of greater than 7.4 but less than 8.4.

The PAEK of the polymeric material may exhibit an absorbance of less than 0.20 at a wavelength of light of 550 nm when measured in accordance with Example 3. Preferably said PAEK exhibits an absorbance of less than 0.18, more preferably less than 0.16, even more preferably less than 0.14, most preferably less than 0.12, at a wavelength of light of 550 nm when measured in accordance with Example 3. Said PAEK may exhibit an absorbance of greater than 0.02, preferably greater than 0.04, more preferably greater than 0.06, at a wavelength of light of 550 nm when measured in accordance with Example 3.

There is further provided an article which comprises, preferably consists essentially of, a polymeric material according to any of the previous aspects or made in the process of the sixth aspect. Said article may be a film, a stock shape such as a rod, or a machined article. Said article may be an injection moulded article, a compression moulded article or an extruded article.

Said film may have a gel/black speck level of less than 300 ppm, preferably less than 250 ppm, more preferably less than 200 ppm, even more preferably less than 180 ppm, when measured in accordance with Example 7.

There is also provided a pack comprising a polymeric material, preferably in the form of powder, pellets and/or granules, as described above.

Said pack may include at least 1 kg, suitably at least 5 kg, preferably at least 10 kg, more preferably at least 14 kg of material of said polymeric material. Said pack may include 1000 kg or less, preferably 500 kg or less of said polymeric material. Preferred packs include 10 to 500 kg of said polymeric material.

Said pack may comprise packaging material (which is intended to be discarded or re-used) and a desired material (which suitably comprises said polymeric material). Said packaging material preferably substantially fully encloses said desired material. Said packaging material may comprise a first receptacle, for example a flexible receptacle such as a plastics bag in which said desired material is arranged. The first receptacle may be contained within a second receptacle for example in a box such as a cardboard box.

According to a further aspect there is provided a process for producing a polymeric material comprising a polyaryletherketone (PAEK), the process comprising the following steps:

a. polycondensing one or more bisphenol with one or more dihalobenzenoid compound, in the presence of

i. less than 0.005 molar ratio of potassium carbonate, and

ii. one or more carbonate of an alkali metal other than potassium carbonate, in a reactor; and

b. isolating the PAEK.

The said molar ratio of potassium carbonate may be defined as:

$$\frac{\begin{matrix}\text{the number of moles of potassium carbonate} \\ \text{used in step} \text{a} \text{of the process}\end{matrix}}{\begin{matrix}\text{the total number of moles of bisphenol} \\ \text{used in step} \text{a} \text{of the process}\end{matrix}}$$

It has surprisingly been found that the process of the further aspect described above provides a PAEK with excellent mechanical and colour properties and contains fewer gels in comparison with known PAEKs.

Preferably step a of the process is carried out in the presence of less than 0.0045 molar ratio of potassium carbonate, more preferably less than 0.0040 molar ratio of potassium carbonate, even more preferably less than 0.0036 molar ratio of potassium carbonate, most preferably less than 0.0032 molar ratio of potassium carbonate. Preferably step a of the process is carried out in the presence of greater than 0.0001 molar ratio of potassium carbonate, more preferably greater than 0.0010 molar ratio of potassium carbonate, even more preferably greater than 0.0020 molar ratio of potassium carbonate, most preferably greater than 0.0025 molar ratio of potassium carbonate. These preferred ranges provide benefits in terms of increased speed of reaction whilst avoiding side reactions that can occur if the rate of reaction is too high.

Said one or more carbonate of an alkali metal other than potassium carbonate may comprise sodium carbonate, sodium bicarbonate, and/or potassium bicarbonate, preferably sodium carbonate.

The total molar ratio of said one or more carbonate of an alkali metal other than potassium carbonate may be at least 0.95, preferably at least 1.00, more preferably at least 1.02, most preferably at least 1.03. The said total molar ratio of said one or more carbonate of an alkali metal other than potassium carbonate is defined as the total number of moles of said one or more carbonate of an alkali metal other than potassium carbonate used in step a of the process divided by the total number of moles of bisphenol used in step a of the process. The total molar ratio of said one or more carbonate of an alkali metal other than potassium carbonate may be less than 1.15, preferably less than 1.10, more preferably less than 1.07, most preferably less than 1.05.

The total molar ratio of carbonates (i.e. the total number of moles of carbonates used in step a of the process divided by the total number of moles of bisphenol used in step a of the process) is suitably at least 1.00, preferably at least 1.02, more preferably at least 1.03, but preferably at most 1.10, more preferably at most 1.06, even more preferably at most 1.05. The term “carbonates” is intended to encompass carbonate (CO₃²⁻) and bicarbonate (HCO₃⁻).

Where step a of the process is carried out in the presence of sodium carbonate, the molar ratio of sodium carbonate used in step a of the process may be greater than 0.95, preferably greater than 1.00, more preferably greater than 1.01, most preferably greater than 1.02. The said molar ratio of sodium carbonate is defined as the number of moles of sodium carbonate used in step a of the process divided by the total number of moles of bisphenol used in step a of the process. The molar ratio of sodium carbonate may be less than 1.15, preferably less than 1.10, more preferably less than 1.06, most preferably less than 1.04.

The molar ratio of carbonates other than sodium carbonate and potassium carbonate used in step a of the process is preferably less than 0.05, more preferably less than 0.01 (again related to the moles of bisphenol used in step a of the process).

Preferably, the only carbonates used in step a of the process are sodium carbonate and potassium carbonate.

Step a of the process may be carried out in the presence of a salt A selected from lithium chloride, calcium chloride, magnesium chloride, lithium bromide, lithium iodide and/or lithium sulphate, preferably lithium chloride. Where step a of the process is carried out in the presence of a salt A, preferably lithium chloride, the molar equivalents of salt A (relative to the moles of potassium carbonate present in step a of the process) may be at least 1.0 molar equivalents, preferably at least 4.0 molar equivalents, more preferably at least 6.0 molar equivalents, most preferably at least 7.0 molar equivalents. The molar equivalents of salt A may be less than 15.0 molar equivalents, preferably less than 12.0 molar equivalents, more preferably less than 10.0 molar equivalents, most preferably less than 9.0 molar equivalents.

The process is preferably carried out in the presence of a solvent. The solvent may be of formula

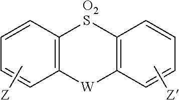

where W is a direct link, an oxygen atom or two hydrogen atoms (one attached to each benzene ring) and Z and Z′, which may be the same or different, are hydrogen atoms or phenyl groups. Examples of such aromatic sulphones include diphenylsulphone, dibenzothiophen dioxide, phenoxanthin dioxide and 4-phenylsulphonyl biphenyl. Diphenylsulphone is a preferred solvent. Step a of the process is preferably carried out in the presence of diphenylsulphone.

Step a of the process may be carried out in the presence of a substantially equimolar ratio of said one or more bisphenol and said one or more dihalobenzoid compound. Preferably step a of the process is carried out in the presence of a molar ratio of dihalobenzoid compound of at least 1.00, preferably at least 1.01, more preferably at least 1.02, but preferably at most 1.07, more preferably at most 1.05, even more preferably at most 1.04. The said molar ratio of dihalobenzoid compound is defined as the number of moles of dihalobenzoid compound used in step a of the process divided by the total number of moles of bisphenol used in step a of the process.

Said one or more bisphenol may comprise hydroquinone, 4,4′-dihydroxybenzophenone, 4,4′-dihydroxybiphenyl, 4,4′-dihydroxydiphenyl ether, 1,4-dihydroxynaphthalene, 2,3-dihydroxynaphthalene and/or 1,6-dihydroxynaphthalene. Preferably said one or more bisphenol comprises hydroquinone, 4,4′-dihydroxybenzophenone and/or 4,4′-dihydroxybiphenyl.

Said one or more dihalobenzenoid compound may comprise 4,4′-dichlorobenzophenone, 4-chloro-4′-fluorobenzophenone, 4,4′-difluorobenzophenone, 1,4-bis(4′-fluorobenzoyl)benzene) and/or 1,3-bis(4′-fluorobenzoyl)benzene. Preferably said one or more dihalobenzenoid compound comprises 4,4′-difluorobenzophenone and/or 1,4-bis(4′-fluorobenzoyl)benzene). Most preferably said one or more dihalobenzenoid compound comprises 4,4′-difluorobenzophenone.

Step a of the process is preferably carried out under substantially anhydrous conditions. Step a is preferably carried out with stirring of the contents of the reactor. The contents of the reactor comprise any components that are present in the reactor. Step a of the process may be carried out at a temperature of from 100° C. to 390° C., preferably from 120° C. to 350° C., more preferably from 130° C. to 320° C. Preferably step a of the process is carried out at a temperature that increases to a maximum temperature of greater than 280° C., more preferably greater than 290° C., even more preferably greater than 300° C., but preferably less than 350° C., more preferably less than 330° C., even more preferably less than 320° C. Preferably the temperature increases at a rate of greater than 0.25° C./min, more preferably greater than 0.50° C./min, even more preferably greater than 0.70° C./min, but preferably less than 1.50° C./min, more preferably less than 1.25° C./min, even more preferably less than 1.10° C./min. Preferably, however, prior to reaching the maximum temperature, step a of the process may further comprise one or more periods of time during which the temperature remains constant. For example, step a of the process may further comprise one or more periods of time (e.g. for at least 20 minutes) during which the temperature is constant and within the range 170-210° C.; and/or during which the temperature is constant within the range 210 to 240° C.

In step a of the process said one or more bisphenol and said one or more dihalobenzenoid compound are preferably brought into contact with each other prior to contacting said potassium carbonate and said one or more carbonate of an alkali metal other than potassium carbonate. Said one or more bisphenol and said one or more dihalobenzenoid compound are preferably brought into contact with each other in the presence of a solvent, preferably diphenylsulphone.

Preferably in step a, prior to reaching the maximum temperature, greater than 1.000 molar ratio, more preferably greater than 1.003 molar ratio, even more preferably greater than 1.005 molar ratio, but preferably less than 1.012 molar ratio, more preferably less than 1.010 molar ratio, even more preferably less than 1.009 molar ratio, of said one or more dihalobenzenoid compound is brought into contact with said one or more bisphenol.

Preferably in step a, after the maximum temperature is reached, said maximum temperature is maintained until a desired molecular weight of the PAEK has been reached. Said desired molecular weight may be indicated by reaching a desired stirrer torque rise. A relationship can be obtained between the molecular weight of the polymer in solution and the torque experienced by a stirrer motor. This is for a defined mass, polymer concentration and temperature. Based on this relationship, a torque rise can be predicted for a desired molecular weight (number average or weight average molecular weight).

Preferably, once said desired molecular weight of the PAEK has been reached, one or more end-capping agent may be added to the reactor. Said end-capping agent may be selected from one or more of a monohalobenzenoid compound such as 4-fluorobenzophenone or monochlorodiphenylsulphone, a dihalobenzenoid compound such as 4,4′-difluorobenzophenone or dichlorodiphenylsulphone, methyl chloride and/or difluorodiketone. Said end-capping agent is preferably selected from 4,4′-difluorobenzophenone and/or 4-fluorobenzophenone. Said end-capping agent is preferably arranged to react with and replace the OH moieties of said bisphenols where present. Said end-capping agent is preferably arranged to end-cap the PAEK produced in the process. As a result, ends of the PAEK suitably include halogen atoms, preferably fluorine atoms, which suitably help to stabilise the PAEK. Preferably greater than 0.004 molar ratio, more preferably greater than 0.006 molar ratio, even more preferably greater than 0.008 molar ratio, most preferably greater than 0.009 molar ratio of end-capping agent is added to the reactor. Preferably less than 0.040 molar ratio, more preferably less than 0.030 molar ratio, even more preferably less than 0.025 molar ratio, most preferably less than 0.022 molar ratio of end-capping agent is added to the reactor. Said molar ratio of end-capping agent is defined as the number of moles of end-capping agent used in step a of the process divided by the total number of moles of bisphenol used in step a of the process.

Preferably said salt A, preferably lithium chloride, is added to the reactor once said desired molecular weight of PAEK has been reached. Said salt A, preferably lithium chloride, may be added to the reactor before said end-capping agent, at the same time as said end-capping agent or after said end-capping agent. Preferably said salt A, preferably lithium chloride, is added to the reactor before said end-capping agent or at the same time as said end-capping agent.

In a preferred embodiment step a of the process comprises:

a. polycondensing one or more bisphenol with one or more dihalobenzenoid compound, in the presence of

i. greater than 0.0025 molar ratio but less than 0.0036 mole % of potassium carbonate, and

ii. greater than 1.01 molar ratio but less than 1.06 molar ratio of sodium carbonate, in a reactor;

wherein step a of the process is carried out in the presence of diphenylsulphone;

wherein step a of the process is carried out at a temperature of from 130° C. to 320° C., and is carried out at a temperature that increases to a maximum temperature of greater than 290° C. but less than 320° C.;

wherein prior to reaching said maximum temperature, greater than 1.005 molar ratio, but less than 1.010 molar ratio of said one or more dihalobenzenoid compound is brought into contact with said one or more bisphenol;

wherein after the maximum temperature is reached, said maximum temperature is maintained until a desired molecular weight of the PAEK has been reached;

wherein once said desired molecular weight of the PAEK has been reached, one or more end-capping agent is added to the reactor;

wherein greater than 0.009 molar ratio but less than 0.025 molar ratio of end-capping agent is added to the reactor;

wherein step a of the process is carried out in the presence of at least 6.0 molar equivalents but less than 10.0 molar equivalents of lithium chloride;

wherein said lithium chloride is added to the reactor once said desired molecular weight of the PAEK has been reached; and

wherein said lithium chloride is added to the reactor before said end-capping agent or at the same time as said end-capping agent.

In said preferred embodiment preferably said one or more bisphenol comprises hydroquinone, 4,4′-dihydroxybenzophenone and/or 4,4′-dihydroxybiphenyl. In said preferred embodiment preferably said one or more dihalobenzenoid compound comprises 4,4′-difluorobenzophenone. In said preferred embodiment preferably said end-capping agent comprises a dihalobenzenoid compound, most preferably 4,4′-difluorobenzophenone.

The process is preferably for producing a polymeric material of any of the first to fourth aspects.

Preferably the polymeric material according to any of the first to fourth aspects is obtainable by or obtained by the process of the seventh aspect.

According to another aspect of the present invention there is provided a use of the process according to the seventh aspect to provide a PAEK with an increased lightness L*, when measured in accordance with Example 6 and with reference to the 1976 CIE L* a* b* colour space.

Any invention described herein may be combined with any feature of any other invention described herein mutatis mutandis.

It will be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

Specific embodiments of the invention will now be described, by way of example, and with reference to the accompanying figures in which:

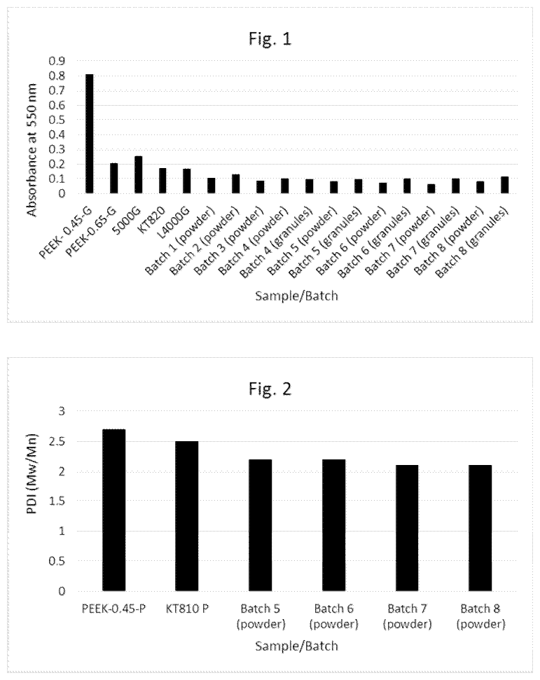

FIG. 1 is a graph showing the absorbance at 550 nm of a solution of a number of inventive and comparative PEEKs as tested in accordance with Example 3;

FIG. 2 is a graph showing the PDI of a number of inventive and comparative PEEKs as tested in accordance with Example 4;

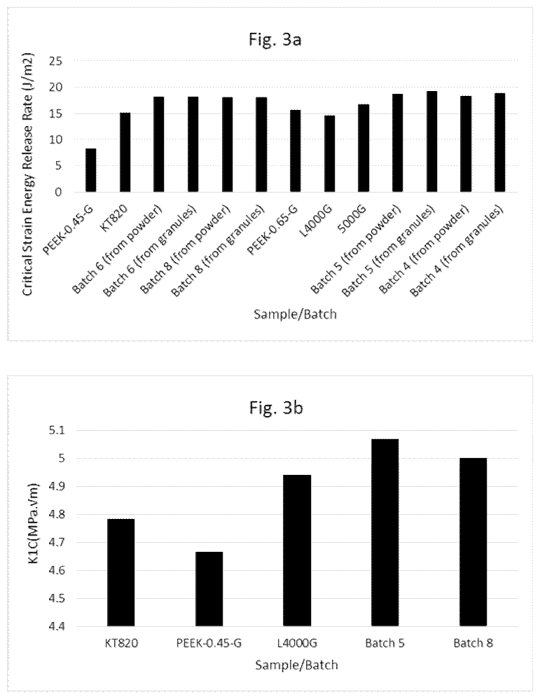

FIG. 3a is a graph showing the critical strain energy release of a number of inventive and comparative PEEKs as tested in accordance with Example 5;

FIG. 3b is a graph showing the stress intensity factor K_{1C} of a number of inventive and comparative PEEKs as tested in accordance with Example 5;

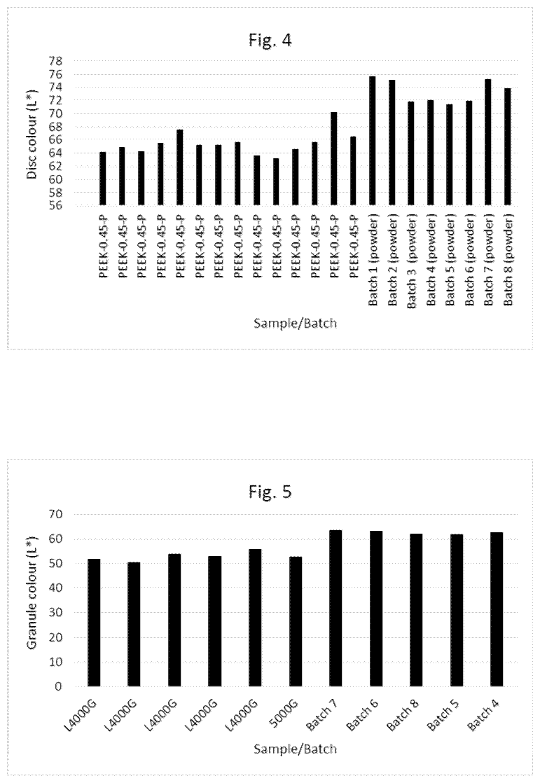

FIG. 4 is a graph showing the lightness (L*) of a number of discs injection moulded from inventive and comparative PEEK powders as tested in accordance with Example 6;

FIG. 5 is a graph showing the lightness (L*) of granules of a number of inventive and comparative PEEKs as tested in accordance with Example 6; and

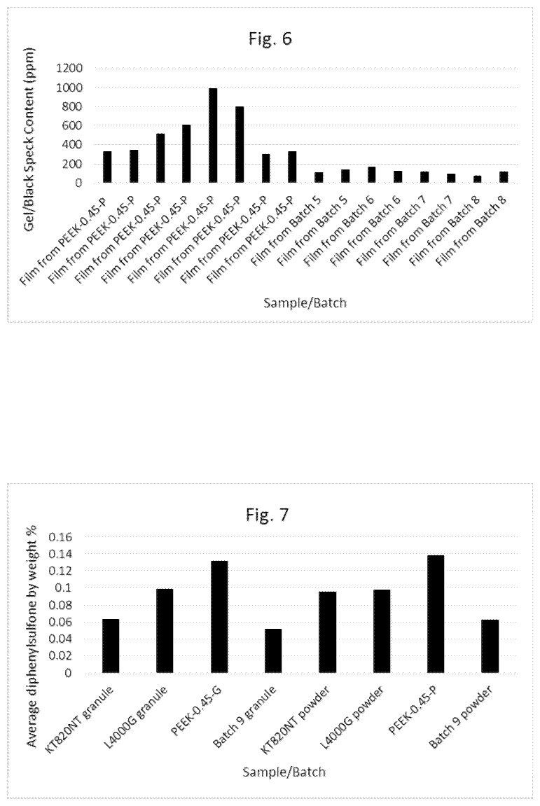

FIG. 6 is a graph showing the gel/black speck content of films extruded from a number of inventive and comparative PEEKs as tested in accordance with Example 7.

The following materials are referred to hereinafter:

PEEK-0.45-P—PEEK powder having a Melt Viscosity of 0.45 kNsm⁻² at 400° C. obtained from Victrex Manufacturing Ltd.

PEEK-0.45-G—PEEK granules having a Melt Viscosity of 0.45 kNsm⁻² at 400° C. obtained from Victrex Manufacturing Ltd.

PEEK-0.65-P—PEEK powder having a Melt Viscosity of 0.65 kNsm⁻² at 400° C. obtained from Victrex Manufacturing Ltd.

PEEK-0.65-G—PEEK granules having a Melt Viscosity of 0.65 kNsm⁻² at 400° C. obtained from Victrex Manufacturing Ltd.

KT810P—Ketaspire KT810P (TM) PEEK powder sold by Solvay.

KT820—Ketaspire KT820 (TM) PEEK granules sold by Solvay.

L4000G—Vestakeep (TM) L4000G PEEK granules sold by Evonik Degussa.

5000G—Vestakeep (TM) 5000G PEEK granules sold by Evonik Degussa.

The comparative PEEK samples made by Victrex Manufacturing Limited were made by a process equivalent to that disclosed in Example 3 of EP3049457A.

The comparative samples from the manufacturers Solvay and Evonik Degussa were made by their proprietary processes, the details of which are not known.

### EXAMPLE 1

### Preparation of Polvetheretherketone (PEEK)

The following describes the preparation of PEEK by a process according to the invention on a laboratory scale. 4,4′-difluorobenzophenone (109.84 g, 0.504 mol), hydroquinone (55.06 g, 0.500 mol) and diphenyl sulfone (225.43 g, 1.033 mol) were weighed into a 0.5 L flask and subjected to an inert nitrogen atmosphere at room temperature overnight. Reactants were then heated to 150° C. During this time the reagents were stirred at 20 rpm for 20 minutes, prior to increasing stirrer speed to 70 rpm for the remainder of the reaction.

Sodium carbonate (54.59 g, 0.515 mol) and potassium carbonate (0.242 g, 1.75 mmol) were added to the reaction mixture over a two minute time period. The reaction temperature was increased to 312° C. at 1° C. min⁻¹. A temperature of 312° C. was maintained until the desired stirrer torque rise was observed.

At this point, lithium chloride (0.595 g, 0.014 mol) was added in one portion, and immediately afterwards, 4,4′-difluorobenzophenone (2.18 g, 0.010 mol) was added in one portion in order to control molecular mass. After a further thirty minutes, the opaque off-white coloured crude product was discharged from the vessel onto a metal tray to cool and solidify.

Once cool, the crude product was milled into a coarse powder (<2 mm maximum dimension). The powder was suspended in acetone in a separating column, and washed with acetone to remove organic impurities, namely diphenyl sulfone solvent. Acetone 1 L) was slowly passed through the column until diphenyl sulfone solvent no longer precipitated out of organic wash on addition of water. The remaining product was then washed with cold deionised water to remove acetone 1 L), prior to hot deionised water 2 L) to remove aqueous by products. Once the conductivity of leachate was measured to be <2 μS using a conductivity probe, the material remaining in the column was dried in an oven overnight, yielding an off-white powder product.

The process above was scaled up to plant scale (based on 386 kg of hydroquinone) in order to obtain 8 batches of PEEK of varying melt viscosities as shown in Table 1 below and as measured according to Example 2. In addition, a portion of five of the eight batches was melt filtered using a single screw extruder (screw speed of 90-110 rpm) and a 20 micrometre pore, 15×7 inch (17.8 cm) Capsule PEEK Filter Housing (available from Porvair Filtration Group Ltd). The melt filtration was carried out at a rate of 50 kg/hr with extruder barrel and die temperatures of 350-390° C. Upon extrusion the melt filtered material was cooled and chopped to obtain cylindrical granules of 2.0 to 3.5 mm diameter and 2.0 to 4.0 mm length.

### EXAMPLE 2

### Melt Viscosity of PEEKs

The Melt Viscosity of the PEEKs was measured using a ram extruder fitted with a tungsten carbide die, 0.5 mm (capillary diameter)×3.175 mm (capillary length). Approximately 5 grams of the PAEK was dried in an air circulating oven for 3 hours at 150° C. The extruder was allowed to equilibrate to 400° C. The dried polymer was loaded into the heated barrel of the extruder, a brass tip (12 mm long×9.92±0.01 mm diameter) placed on top of the polymer followed by the piston and the screw was manually turned until the proof ring of the pressure gauge just engages the piston to help remove any trapped air. The column of polymer was allowed to heat and melt over a period of at least 5 minutes. After the preheat stage the screw was set in motion so that the melted polymer was extruded through the die to form a thin fibre at a shear rate of 1000 s⁻¹, while recording the pressure (P) required to extrude the polymer. The Melt Viscosity is given by the formula

$$Melt Viscosity = \frac{P π {r}^{4}}{8 L S A} {kNsm}^{- 2}$$

where P=Pressure/kN m⁻²
   L=Length of die/m
   S=ram speed/ms⁻¹
   A=barrel cross-sectional area/m²
   r=Die radius/m
The relationship between shear rate and the other parameters is given by the equation:

$$\text{Apparent wall shear rate} = 1000 {s}^{- 1} = \frac{4 Q}{π {r}^{3}}$$

where Q=volumetric flow rate/m³ s⁻¹=SA.

TABLE 1
Melt viscosities of PEEK batches prepared
in accordance with the present invention.

| PEEK Batch | MV (kNsm⁻²) |
|---|---|
| Batch 1 | 0.176 |
| Batch 2 | 0.216 |
| Batch 3 | 0.456 |
| Batch 4 | 0.797 |
| Batch 5 | 0.770 |
| Batch 6 | 0.595 |
| Batch 7 | 0.571 |
| Batch 8 | 0.623 |

### EXAMPLE 3

### UV-Vis Absorbance of PEEKs

The extent of carbonyl branching in a number of PEEKs according to the present invention and comparative PEEKs was determined according to the following method. 1.0 g of PEEK was accurately weighed out and added to a 100 ml volumetric flask. PEEK powder samples and melt filtered granule samples, both according to the present invention, were tested. The comparative samples were all granule samples. Concentrated sulfuric acid (70 ml, specific gravity 1.84 g/ml at 25° C., 95-98 wt. %) was added to the flask—for dissolution purposes (and to avoid the PEEK sticking in the neck of the flask) initially only three quarters of the volumetric flask was filled. The volumetric flask was capped and left on a shaker for around 18 to 30 hours (or, if using granules, until dissolved which was found to take as long as 2 to 4 days depending on the size of the granules). Once dissolved, the flask was filled to the 100 ml mark with further concentrated sulfuric acid and its contents were shaken to provide a resultant solution.

The absorbance arising from the dissolved polymer of the samples at 550 nm was then measured using a twin beam instrument such as a Jasco V-630 spectrophotometer fitted with USE-753 cell holder. The spectrophotometer settings were absorbance mode, a measurement range of 1000 nm to 400 nm, data Interval of 0.2 nm, a UV/Vis bandwidth of 1.5 nm, a scan speed of 100 nm/min and a halogen D2/WI light source.

The test solution was placed in a 10 mm quartz cuvette (ref. 100-QS) and concentrated sulfuric acid (specific gravity 1.84 g/ml at 25° C., 95-98 wt. %) placed in a separate 100-QS cell to act as a reference sample. The sample path length was 10 mm. After running a baseline spectrum with the cell holders empty, the cuvette containing the dissolved PEEK sample (resultant solution) was placed in the ‘sample’ beam and the cuvette with the concentrated sulfuric acid sample was placed in the ‘reference’ beam.

The light from the halogen lamp was focused and entered the monochromator, the light being dispersed by the grating in the monochromator and focused onto an exit slit. The light that passed through the exit slit was monochromated. The light was split into two beams, one going to the polymer solution to be measured and the other to the sulfuric acid reference sample. The light that passed through the reference and the polymer sample was incident on a silicon photodiode detector. The intensity of the light passing through the reference cell (lo) was measured for each wavelength of light passing through the spectrometer. Similarly, the intensity of the light passing through the sample cell (I) was also measured for each wavelength. Consequently, if the measured intensity of light passing through the sample cell (I) was less than the measured light passing through the reference sample (lo), the polymer sample had thereby absorbed a proportion of the light passing through the sample. This measured difference in the intensity of light passing through the polymer and reference sample was converted into a measure of absorbance, A.

The relationship between A and the intensity of light passing through the polymer sample (I) and the reference sample (lo) can be represented as:

$$A = {log}_{10} \frac{{I}_{o}}{I}$$

The absorbance at light at a wavelength of 550 nm was measured from the resultant spectra output by the Jasco spectra Manager software.

The reference beam intensity after transmission through the reference is calibrated as 100% transmission or an absorbance measure of A=0, such that the value −log₁₀(T_{S}/T_{R}) for Absorbance corresponds solely to the contribution to absorbance from the dissolved polymer.

As explained above, the measured absorbance provides an indication of the level of carbonyl branching of the dissolved PAEK.

The measured absorbances are shown in Table 2 below and in FIG. 1.

TABLE 2
Extent of carbonyl branching in a number of inventive and
comparative samples as shown by absorbance at 550 nm

| Sample/Batch | Absorbance at 550 nm |
|---|---|
| PEEK- 0.45-G | 0.8132 |
| PEEK-0.65-G | 0.2075 |
| 5000G | 0.2544 |
| KT820 | 0.1747 |
| L4000G | 0.1695 |
| Batch 1 (powder) | 0.1102 |
| Batch 2 (powder) | 0.1306 |
| Batch 3 (powder) | 0.0905 |
| Batch 4 (powder) | 0.1040 |
| Batch 4 (granules) | 0.0989 |
| Batch 5 (powder) | 0.0845 |
| Batch 5 (granules) | 0.1006 |
| Batch 6 (powder) | 0.0733 |
| Batch 6 (granules) | 0.1026 |
| Batch 7 (powder) | 0.0682 |
| Batch 7 (granules) | 0.1031 |
| Batch 8 (powder) | 0.0834 |
| Batch 8 (granules) | 0.1192 |

As can be seen from Table 2 and FIG. 1, the PEEKs of the present invention absorb less light at a wavelength of 550 nm compared with the other PEEK samples measured. Therefore, PEEKs of the present invention have a lower level of carbonyl branching than the comparative samples tested i.e. the PEEKs of the present invention are substantially more straight-chained than the comparative PEEKs. This structural difference lends itself to a number of advantageous properties as shown below.

### EXAMPLE 4

### Molecular Mass Dispersity or Polydispersity Index (PDI) of PEEKs

The polydispersity of a number of samples was then tested as follows. Each sample solution was prepared by dissolving 40 mg of PEEK powder in 2 ml of 4-chlorophenol (PCP) at 205° C. The solution was then cooled, diluted to 20 ml with chloroform and filtered through a 0.45 μm PTFE syringe filter before analysis.

Gel Permeation Chromotography Conditions:

Columns 2× Agilent PLGel Mixed B, 300×7.8 mm

Solvent 10% w/v PCP in chloroform

Flow rate 1.0 ml/min

Temperature 35° C.

Detector Refractive index

The data was collected and analysed using Viscotek Omnisec 5.1 software. The system was calibrated using Agilent Easi Cal polystyrene standards. All molecular mass results reported are expressed as ‘polystyrene equivalent’ molecular masses. The PDI values for batches 5-8 of the present invention and two comparative samples are shown below in Table 3 and in FIG. 2.

TABLE 3
PDI values for a number of inventive and comparative samples

| Sample/Batch | PDI (Mw/Mn) |
|---|---|
| PEEK-0.45-P | 2.7 |
| KT810 P | 2.5 |
| Batch 5 (powder) | 2.2 |
| Batch 6 (powder) | 2.2 |
| Batch 7 (powder) | 2.1 |
| Batch 8 (powder) | 2.1 |

As is apparent from Table 3 and FIG. 2, the PEEKs of the present invention have a far lower dispersity (PDI), i.e. a far narrower distribution of molecular mass, in comparison with the comparative examples. Indeed, the PEEKs of the present invention exhibit PDIs that approach a PDI of 2.0.

### EXAMPLE 5

### Critical Strain Enemy Release Rate and Stress Intensity Factor of PEEKs

A standard test method for strain energy release rate (ASTM D 5045—99) was modified for use with test bars that could be produced in-house, to give a modified test method that was consistent with ductility behaviour in various applications. The modified test method uses energy release rate (per unit area) rather than stress-intensity as a measure of toughness.

Differences between ASTM test method D 5045-99 and modified test method:

Equipment

An ASTM flex support (51 mm span) and anvil were used rather than the Bending Rig shown in FIG. 1 of the ASTM test method. Test bars were tested using an Instron 5567 tensometer with 30kN load cell.

A loading-pin penetration and sample compression calibration (mentioned in 6.2.1 of the ASTM method) was not carried out.

A crosshead speed of 100 mm/min was used rather than the recommended 10 mm/min.

Sample Preparation

The test bars were slightly trapeze shaped rather than the specified rectangular prisms of the ASTM method. The test bars were injection moulded from powder and from granules in the case of the samples of the invention and from granules in the case of the comparative samples.

The sample size falls into the ‘alternative specimens’ category described in A1.1.2—it does not meet the specifications in 7.1.1. For the specimens tested W=12.7 mm, B=6.3 mm, a=4.7 mm.

The samples were machine notched as described in the ASTM method but no subsequent initiation of a natural crack was carried out (see 7.4.1 of the ASTM method).

Interpretation of Results

A graph of Flexure Extension (x-axis) versus Flexure Load (y-axis) was plotted.

The line AB mentioned in 9.1.1 of the ASTM method was not drawn as a ‘best straight line’ but instead A was taken as the flexure extension result closest to a flexure load of 200 N, B was the flexure extension result closest to a flexure load of 300 N. A line was drawn between A and B which was extrapolated back to the x-axis and this point was labelled C. The line AB′, described in the ASTM method, was not used.

Critical Strain Energy Release Rate (G_{lc}) was determined directly from the energy derived from integration of the load versus displacement curve as described in 9.3 of the ASTM method however it was integrated from point C (described above) up to Pₘₐₓ rather than up to P_{Q}. The results are reported in Table 4a and in FIG. 3a in J/m².

TABLE 4a
Critical Strain Energy Release Rate of samples according
to the present invention and comparative samples

| | | Critical Strain Energy |
|---|---|---|
| Sample/Batch | MV (kNsm⁻²) | Release Rate (J/m²) |
| PEEK-0.45-G | 0.436 | 8.27 |
| KT820 | 0.598 | 15.08 |
| Batch 6 (from powder) | 0.622 | 18.27 |
| Batch 6 (from granules) | 0.622 | 18.27 |
| Batch 8 (from powder) | 0.636 | 18.03 |
| Batch 8 (from granules) | 0.636 | 18.03 |
| PEEK-0.65-G | 0.643 | 15.67 |
| L4000G | 0.646 | 14.55 |
| 5000G | 0.708 | 16.74 |
| Batch 5 (from powder) | 0.770 | 18.69 |
| Batch 5 (from granules) | 0.770 | 19.25 |
| Batch 4 (from powder) | 0.797 | 18.35 |
| Batch 4 (from granules) | 0.797 | 18.89 |

It is well known to persons skilled in the art that fracture toughness increases with MV (and with molecular mass). Accordingly the data in Table 4a and in FIG. 3a has been presented in order of MV to show how the fracture toughness varies between materials of a similar MV. The data in Table 4a and FIG. 3a clearly show that for given MVs the PEEKs of the present invention demonstrate greater critical strain energy release rate, which is a measure of fracture toughness, than several comparative PEEKs. As detailed on page 1, a material with higher fracture toughness properties is particularly advantageous for use in thicker walled parts e.g. stock shapes including rods, machined components, extruded articles and in composites generally.

Stress Intensity factor K_{1C}

The fracture toughness was measured using a test method as described in ISO17281:2002 on injection moulded granules of the present invention. The fracture toughness was determined by measuring of the stress intensity factor K_{1C} which is identified as the point at which a thin crack in a material begins to grow.

TABLE 4b
Measurement of stress intensity factor K_{1C}

| Sample/Batch | K_{1C}(MPa · √m) |
|---|---|
| KT820 | 4.784 |
| PEEK-0.45-G | 4.667 |
| L4000G | 4.940 |
| Batch 5 (from granule) | 5.067 |
| Batch 8 (from granule) | 5.002 |

Table 4b and FIG. 3b show that PEEKs of the present invention have a greater stress intensity factor K_{1C} compared with other PEEKs. Therefore, PEEKs of the present invention have a high resistance to brittle fracture when a crack is present, and any propagation of a crack through the PEEK material of the present invention will undergo more ductile fracture.

As a result of this characteristic of the PEEK of the invention, the polymer is of particular use for the preparation of formed and moulded enclosures for electronic devices, particularly portable electronic devices which may be easily dropped, for instance portable smartphones and tablets.

For example, a casing for an electronic device form a composition comprising, substantially consisting of or consisting of PEEK of the present invention is provided. A casing for an electronic device includes an enclosure for a portable device such as a smart phone. The enclosure may be a moulded enclosure. Alternatively, the enclosure may be formed through an additive manufacturing process. An enclosure comprising, substantially consisting of or consisting PEEK of the present invention is particularly good at withstanding the stresses and strains of prolonged everyday use because the PEEK of the present invention has a high resistance to brittle fracture. Furthermore, enclosures comprising PEEK of the present invention are more able to withstand defects formed during manufacture of the enclosures, since small manufacturing defects can cause cracks that can propagate through the enclosures, and the PEEK of the present invention is more resistant to brittle fracture than other known PEEKs.

The composition of the casing may comprise from 30 to 100% of the PAEK or PEEK of the invention with from 0 to 70% by weight of other components such as filler, for instance fibrous filler, glass filler, colourants and the like. Preferably the composition of the casing comprises no other PAEK or PEEK, more preferably no other polymer.

### EXAMPLE 6

### Colour of PEEKs

The colour of inventive and comparative PEEKs was tested using Minolta CR400 and CR410 chromameters. Powder samples were first injection moulded into discs having a substantially flat surface for colour measurement using a 40t Engel Injection Moulder, and their colour evaluated using the Minolta CR400 chromameter. Granular samples had a granule size from 1 to 10 mm as determined by sieving and were placed into a granular materials attachment and their colour measured using the Minolta CR410 chromameter. Colour was measured in terms of L*, a* and b* values with reference to the 1976 CIE L* a* b* colour space.

Colour Evaluation of the Samples

Injection moulded discs from powder: For each disc, the measuring head was placed flat to the centre of the disc and a reading taken.

Granules: The granular materials attachment was inverted so that the granules were pressed against a glass window of the attachment when analysed. The granules filled the window and were stationary when a reading was taken. The measuring head was placed flat to the window when a reading was taken.

Discs Moulded from Powder:

A number of different samples of PEEK-0.45-P were measured in order to demonstrate the expected variability in the results

TABLE 5
Colour data for discs moulded from powder
of inventive PAEKs and comparative PAEKs

| | Disc | Disc | Disc | MV |
|---|---|---|---|---|
| Sample/Batch | colour (L*) | colour (a*) | colour (b*) | (kNsm⁻²) |
| PEEK-0.45-P | 64.2 | 1.4 | 13.5 | 0.471 |
| PEEK-0.45-P | 64.9 | 1.2 | 11.8 | 0.448 |
| PEEK-0.45-P | 64.3 | 1.9 | 13.5 | 0.482 |
| PEEK-0.45-P | 65.6 | 2.5 | 10.1 | 0.483 |
| PEEK-0.45-P | 67.6 | 1.9 | 11.8 | 0.471 |
| PEEK-0.45-P | 65.2 | 1.2 | 15.6 | 0.454 |
| PEEK-0.45-P | 65.2 | 1.6 | 12.1 | 0.470 |
| PEEK-0.45-P | 65.7 | 1.7 | 11.6 | 0.492 |
| PEEK-0.45-P | 63.6 | 1.7 | 12.3 | 0.507 |
| PEEK-0.45-P | 63.2 | 1.9 | 12.3 | 0.531 |
| PEEK-0.45-P | 64.6 | 1.6 | 13.2 | 0.476 |
| PEEK-0.45-P | 65.7 | 1.5 | 12.6 | 0.441 |
| PEEK-0.45-P | 70.3 | 2.2 | 9.3 | 0.442 |
| PEEK-0.45-P | 66.5 | 1.7 | 11.9 | 0.508 |
| Batch 1 | 75.7 | 1.2 | 8.8 | 0.176 |
| (from powder) | | | | |
| Batch 2 | 75.1 | 1.7 | 8.0 | 0.216 |
| (from powder) | | | | |
| Batch 3 | 71.8 | 2.0 | 8.9 | 0.456 |
| (from powder) | | | | |
| Batch 4 | 72.1 | 2.5 | 8.3 | 0.797 |
| (from powder) | | | | |
| Batch 5 | 71.4 | 2.3 | 9.5 | 0.770 |
| (from powder) | | | | |
| Batch 6 | 72.0 | 2.2 | 9.3 | 0.595 |
| (from powder) | | | | |
| Batch 7 | 75.3 | 3.0 | 7.2 | 0.571 |
| (from powder) | | | | |
| Batch 8 | 73.9 | 3.1 | 7.2 | 0.623 |
| (from powder) | | | | |

Granules:

TABLE 6
Colour data for granules of inventive
PEEKs and comparative PEEKs

| | Granule | Granule | Granule |
|---|---|---|---|
| Sample/Batch | colour (L*) | colour (a*) | colour (b*) |
| L4000G | 51.95 | 1.51 | 8.10 |
| L4000G | 50.34 | 1.51 | 7.56 |
| L4000G | 53.90 | 1.63 | 8.03 |
| L4000G | 52.97 | 1.62 | 3.98 |
| L4000G | 55.74 | 1.54 | 4.02 |
| 5000G | 52.84 | 1.94 | 3.90 |
| Batch 7 | 63.58 | 2.20 | 7.99 |
| Batch 6 | 63.20 | 2.18 | 8.30 |
| Batch 8 | 62.25 | 2.29 | 7.55 |
| Batch 5 | 61.80 | 2.29 | 8.03 |
| Batch 4 | 62.59 | 2.33 | 8.12 |

Tables 5 and 6 respectively show that the discs moulded from powder according to the present invention and the granules according to the present invention exhibit a* and b* values that are generally equivalent to those of the comparative samples. However, the L* values of the inventive samples are higher than those of the comparative samples, which means that overall the samples of the present invention appear lighter and whiter than the comparative PAEKs. The L* values for the discs moulded from powder and for the granules are also shown in FIGS. 4 and 5 respectively.

### EXAMPLE 7

### Gel/Black Speck Content of PEEKs

Gel/black speck content was assessed by a Brabender Film Quality Analyzer on amorphous extruded films prepared from inventive and comparative melt filtered powder. Extrusion conditions were:

Gravity fed, single screw 20 mm extruder set at 60 rpm

All heating zones set at 380° C.

Chill rollers set to 100° C.

Film speed set at 2.8 m/min.

The films were 100 micron thick and 45 to 50 mm wide.

Gels and black specks were detected by Brabender Film Quality Analyzer using a cold light source on a 1.2 m² surface of film.

Gels are defined as defects with a transmittance of 25 to 70%.

Black specks are defined as defects with a transmittance of below 25%.

Transmittance of above 70% is defined as transparent.

Film defect results are expressed as a parts per million (ppm) count. By measuring the total number of pixels observed in a digital scan, and analysing how many pixels absorb light at a transmittance greater than the predefined transmittance as described above.

TABLE 7
Gel/black speck content of inventive and comparative samples

| Sample/Batch | Gel/Black Speck Content (ppm) |
|---|---|
| Film from PEEK-0.45-P | 333 |
| Film from PEEK-0.45-P | 349 |
| Film from PEEK-0.45-P | 513 |
| Film from PEEK-0.45-P | 613 |
| Film from PEEK-0.45-P | 989 |
| Film from PEEK-0.45-P | 805 |
| Film from PEEK-0.45-P | 307 |
| Film from PEEK-0.45-P | 332 |
| Film from Batch 5 | 110 |
| Film from Batch 5 | 140 |
| Film from Batch 6 | 170 |
| Film from Batch 6 | 127 |
| Film from Batch 7 | 119 |
| Film from Batch 7 | 98 |
| Film from Batch 8 | 79 |
| Film from Batch 8 | 123 |

It will be immediately apparent from the values shown in Table 7 and in FIG. 6 that the PEEKs of the present invention have a far lower content of gels/black specks than the comparative PEEKs. This means that the PEEKs of the present invention are better suited for use in e.g. films and melt-spun fibres than the comparative PEEKs.

As a result of this characteristic of the PEEK of the invention, the polymer is of particular use for the preparation of polymeric film as there is a lower incidence of defects in the resultant films. PEEK of the invention improves the effective yield of good quality, defect-free polymer film, and hence decreases the amount of waste material.

### EXAMPLE 8

### Determination of Content of 4,4′-Difluorobenzophenone in Miglyol Extracts

The level of extractable 4,4′-difluorobenzophenone was measured using High-performance liquid chromatography (HPLC) on Miglyol 812 sample extracts. Samples of PEEKs were placed in a vessel of Miglyol 812 and the vessels were placed in an oven held at 175° C. The amount of residual 4,4′-difluorobenzophenone extracted from each PEEK sample was measured by analysing the Miglyol 812 using HPLC.

The Miglyol 812 samples were analysed by HPLC with diode array detection using an Agilent 1260 HPLC system. The HPLC column was an Ascentis express ES-CN, having dimensions 150 mm×3.0 mm and a particle size of 2.7 micrometres. Mobile phases comprised A=0.5% v/v acetic acid in water and B=0.5% v/v acetic acid in acetonitrile. The flow rate was set at 0.4 ml/minute. The run time was 26 minutes and the post equilibrium time was 15 minutes. The injection volume was 5 micro litres and the column temperature was 20° C. UV detection was set at 254 nm with a band width of 4 nm and the UV flow cell was 6 cm. The solvent gradient was as follows: at time (minutes)=0, A=95%, B=5%; at time (minutes)=5, A=95%, B=5%; at time (minutes)=20, A=30%, B=70%; at time (minutes)=21, A=0%, B=100%; at time (minutes)=25, A=0%, B=100%; and at Time (minutes)=26, A=95%, B=5%.

Miglyol 812 is a standard fatty food simulant used to monitor the amount of fat-extractable residues in polymers. A number of samples of PEEK were exposed via total immersion in 100 ml of Miglyol 812 and held at 175° C. Each PEEK sample had the following dimensions: 2.5 cm×2.5 cm×2 mm. A sample of the Mygliol 812 was analysed by HPLC to identify the amount of residual 4,4′-difluorobenzophenone extracted from the PEEK sample into the Miglyol 812 sample after the PEEK sample had been immersed in the Miglyol 812 for six hours at 175° C.

TABLE 8
Measurements of extracted 4,4′-difluorobenzophenone
in Migylol 812

| | Amount of 4,4′-difluorobenzophenone | |
|---|---|---|
| | extracted from PEEK immersed in Migylol | |
| Sample/Batch | extract after 6 hours at 175° C. | |
| KT820NT | 0.173 | mg/kg |
| L4000G | 0.090 | mg/kg |
| Batch 8 | <0.04 | mg/kg |

Table 8 shows that the measured levels of 4,4′-difluorobenzophenone extracted from the PEEK of the present invention into the Migylol 812 does not exceed regulatory levels of the specific migration of 4,4′-difluorobenzophenone. The measured migration of 4,4′-difluorobenzophenone, for PEEK of the present invention, was identified as less than 0.04 mg/kg of PEEK, and below the maximum allowed level specified in the European Commission Regulation (EU) No 10/2011 of 14 January 2011 on plastics materials and articles intended to come into contact with food when tested with Miglyol 812 at a high temperature of 175° C. under short term repeat use test conditions. Therefore, PEEK of the present invention has been found to be suitable for use in articles intended to come into contact with food.

As a result of this characteristic of the PEEK of the invention, the polymer is of particular use for the preparation of devices and components for use in the food industry, particularly components that come into direct contact with food such as components of coffee machines, blenders, mixers and other food preparation equipment or components thereof (such as liners, gears, filters, sieves, belting and extrusion nozzles and the like). As such, the invention provides a component for a machine for use in food and/or beverage preparation, wherein the component comprises PEEK of the present invention. The PEEK of the present invention is also particularly suitable for coating belts of conveyors used in the food industry for conveying food products.

### EXAMPLE 9

### Measurement of Residual Diphenylsulfone

Residual amounts of diphenylsulfone were assessed using a standard method for measuring total sulfur in light hydrocarbons, spark ignition engine fuel, diesel engine fuel, and engine oil by ultraviolet fluorescence (ASTM Standard D5453-16).

The test method measures the amount of sulfur dioxide in the materials tested. The measurement of the amount of sulfur dioxide enables the calculation of the amount of diphenylsulfone (DPS) in the materials.

TABLE 9
Levels of diphenylsulfone in PEEKs

| Sample/Batch | Average diphenylsulfone by weight % |
|---|---|
| KT820NT granule | 0.064 |
| L4000G granule | 0.099 |
| PEEK-0.45-G | 0.132 |
| Batch 9 granule | 0.052 |
| KT820NT powder | 0.096 |
| L4000G powder | 0.098 |
| PEEK-0.45-P | 0.139 |
| Batch 9 powder | 0.063 |

Table 9 and FIG. 7 show that PEEK of the present invention has a lower average residual amount of diphenylsulfone expressed as an average weight percent relative to polymer.

Surprisingly, further leaching of the PEEKs was found to be ineffective at removal of further DPS. Without being bound by theory, the more linear PEEK polymer of the present invention is believed to crystallise more slowing so that the crystallites crystallise around any residual DPS resulting in a more porous powder from which more DPS can be leached.

### EXAMPLE 10

### Measurement of Pipe Strength

The strength of a pipe can be determined by measuring the burst pressure of the pipe. The pipe was made according to the Standard as recited in American Petroleum Institute API 17E Ed 4 (2010) which recites a specification for subsea umbilicals.

A simple test was carried out to determine the burst pressure of the pipe. First, a 1 m length of pipe of each sample was cut. The pipe had a nominal diameter of 15.6 mm. Then, suitable inserts and ferrules were swaged, using a swaging machine fitted with suitable inserts depending on the ferrule size, on to both ends of all of the pipes to make the test sample. Blanking caps were positioned on to one end of each test sample and were tightened. The test samples were then filled with water, avoiding air bubbles and a male hydraulic quick release fitting was attached to the other end of each test sample and fully tightened.

The test sample was then placed in to a pressure test tank and connected to a female quick release fitting. The test pressure was applied by slowly opening the valve on the test pump, such that the pressure increased gradually with a maximum pressure being achieved between 30 s & 60 s of starting the test.

The maximum test pressure achieved prior to pipe failure was recorded and is shown in Table 10.

TABLE 10
Measurement of pipe strength

| Sample | Maximum burst pressure (Psi) |
|---|---|
| PEEK-0.65 pipe | 193.48 |
| Batch 10 pipe | 179.2 |

Surprisingly, pipe made from PEEK polymer of the present invention was found to have a higher burst strength when compared with pipe made from comparative polymer. The pipe made from PEEK polymer of the present invention had a 7% increase in the amount of pressure the pipe could withstand without failure. Therefore pipe made from PEEK polymer of the present invention is tougher and it follows that a thinner walled pipe of the present invention would give an equivalent burst strength to a thicker walled standard PEEK pipe.

The PEEKs of the present invention are particularly suited to a variety of different forms including film, pipes, tubing and wire coating and stock shapes. This is in part due to the reduced levels of residual stresses in the PEEK. The lower levels of branching found in PEEK of the present invention result in a more linear molecule which helps to reduce the residual stresses that may build up in the different forms. This is especially useful in pipes and tubing whereby residual stresses can cause the pipes and tubing to shatter when cut.

There is also disclosed a polymeric material comprising a polyaryletherketone (PAEK), wherein said PAEK has a polydispersity index (PDI) of less than 2.6, when measured in accordance with Example 4.

While it is known to those skilled in the art that the theoretical minimum PDI for step-growth polymerisation is 2.0, it has surprisingly been found that the PAEK of the present invention approaches this theoretical limit. PDI is a measure of the distribution of molecular mass in a given polymer sample and is calculated in accordance with the following equation:

PDI=Mw/Mn

where Mw=weight average molecular weight and
Mn=number average molecular weight.

The PAEK demonstrates excellent mechanical and colour characteristics and has a lower frequency of gels in comparison with known PAEKs.

In an example, said PAEK has a polydispersity index (PDI) of less than 2.5, more preferably less than 2.4, even more preferably less than 2.3, most preferably less than 2.2, when measured in accordance with Example 4.

There is further provided a polymeric material comprising a polyaryletherketone (PAEK), wherein when said polymeric material is in the form of melt-filtered granules, said polymeric material has a lightness L* of greater than 56.0, an a* coordinate of greater than 1.3 but less than 5.0, and a b* coordinate of greater than 6.5 but less than 10.0, when measured in accordance with Example 6 and with reference to the 1976 CIE L* a* b* colour space.

It has surprisingly been found that the PAEK of the present invention is lighter and consequently appears whiter than known PAEKs. As detailed above, lighter/whiter PAEKs are useful because they enable ease of colour matching with similarly coloured components and their colour can be more easily adjusted.

Preferably said polymeric material has a lightness L* of greater than 58.0, more preferably greater than 59.0, even more preferably greater than 60.0, most preferably greater than 61.0.

Preferably said polymeric material has an a* coordinate of greater than 1.5 but less than 3.5, more preferably greater than 1.8 but less than 3.0, even more preferably greater than 2.0 but less than 2.5, most preferably greater than 2.1 but less than 2.4.

Preferably said polymeric material has a b* coordinate of greater than 6.7 but less than 9.0, more preferably greater than 7.0 but less than 8.7, even more preferably greater than 7.2 but less than 8.5, most preferably greater than 7.4 but less than 8.4.

In another example said polymeric material has a lightness L* of greater than 60.0, an a* coordinate of greater than 2.0 but less than 2.5, and a b* coordinate of greater than 7.2 but less than 8.5. In a more preferred embodiment said polymeric material has a lightness L* of greater than 61.0, an a* coordinate of greater than 2.1 but less than 2.4, and a b* coordinate of greater than 7.4 but less than 8.4.

There is also provided a polymeric material comprising a polyaryletherketone (PAEK), wherein when said polymeric material is in the form of an article injection moulded from a powder,

said polymeric material has a lightness L* of greater than 65.0, an a* coordinate of greater than 0.2 but less than 5.0, and a b* coordinate of greater than 5.0 but less than 12.0, when measured in accordance with Example 6 and with reference to the 1976 CIE L* a* b* colour space.

Preferably said article is a disc or a plaque.

Preferably said polymeric material has a lightness L* of greater than 67.0, more preferably greater than 69.0, even more preferably greater than 70.0, most preferably greater than 71.0.

Preferably said polymeric material has an a* coordinate of greater than 0.5 but less than 4.5, more preferably greater than 0.8 but less than 4.0, even more preferably greater than 1.0 but less than 3.5, most preferably greater than 1.1 but less than 3.2.

Preferably said polymeric material has a b* coordinate of greater than 5.5 but less than 11.0, more preferably greater than 6.0 but less than 10.5, even more preferably greater than 6.5 but less than 10.0, most preferably greater than 7.0 but less than 9.7.

In a preferred embodiment said polymeric material has a lightness L* of greater than 70.0, an a* coordinate of greater than 1.0 but less than 3.5, and a b* coordinate of greater than 6.5 but less than 10.0. In a more preferred embodiment said polymeric material has a lightness L* of greater than 71.0, an a* coordinate of greater than 1.1 but less than 3.2, and a b* coordinate of greater than 7.0 but less than 9.7.

The following are clauses relating to the disclosure.

1. A polymeric material comprising a polyaryletherketone (PAEK),

wherein when said PAEK is dissolved in 1% w/v aqueous sulphuric acid to prepare a resultant solution, said resultant solution exhibits an absorbance of less than 0.20 at a wavelength of light of 550 nm, wherein said preparation of said resultant solution and measurement of its absorbance are carried out in accordance with Example 3.

2. The polymeric material according to clause 1, wherein said resultant solution exhibits an absorbance of less than 0.18, preferably less than 0.16, more preferably less than 0.14, most preferably less than 0.12, at a wavelength of light of 550 nm when measured in accordance with Example 3.

3. A polymeric material comprising a polyaryletherketone (PAEK),

wherein said PAEK has a polydispersity index (PDI) of less than 2.6, when measured in accordance with Example 4.

4. The polymeric material according to clause 3, wherein said PAEK has a polydispersity index (PDI) of less than 2.5, preferably less than 2.4, more preferably less than 2.3, most preferably less than 2.2, when measured in accordance with Example 4.

5. A polymeric material comprising a polyaryletherketone (PAEK),

wherein when said polymeric material is in the form of melt-filtered granules,

said polymeric material has a lightness L* of greater than 56.0, an a* coordinate of greater than 1.3 but less than 5.0, and a b* coordinate of greater than 6.5 but less than 10.0, when measured in accordance with Example 6 and with reference to the 1976 CIE L* a* b* colour space.

6. The polymeric material according to clause 5, wherein said polymeric material has a lightness L* of greater than 60.0, an a* coordinate of greater than 2.0 but less than 2.5, and a b* coordinate of greater than 7.2 but less than 8.5.

7. A polymeric material comprising a polyaryletherketone (PAEK),

wherein when said polymeric material is in the form of an article injection moulded from a powder,

said polymeric material has a lightness L* of greater than 65.0, an a* coordinate of greater than 0.2 but less than 5.0, and a b* coordinate of greater than 5.0 but less than 12.0, when measured in accordance with Example 6 and with reference to the 1976 CIE L* a* b* colour space.

8. The polymeric material according to clause 7, wherein said polymeric material has a lightness L* of greater than 70.0, an a* coordinate of greater than 1.0 but less than 3.5, and a b* coordinate of greater than 6.5 but less than 10.0.

9. The polymeric material according to any preceding clause, wherein said PAEK comprises a repeat unit of formula:

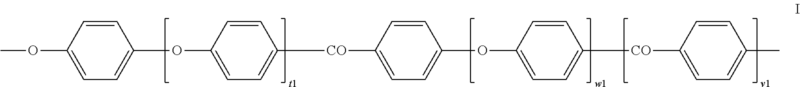

wherein t1 and w1 independently represent 0 or 1 and v1 represents 0, 1 or 2.

10. The polymeric material according to any preceding clause, wherein said PAEK is selected from polyetheretherketone and/or a copolymer including polyetheretherketone and polyetherdiphenyletherketone.

11. The polymeric material according to any preceding clause, wherein said polymeric material has a critical strain energy release rate (as tested in accordance with example 5) of at least 17.5 Jm⁻², preferably at least 17.8 Jm⁻², more preferably at least 18.0 KJm⁻².

12. The polymeric material according to any preceding clause, wherein said polymeric material further comprises one or more filler.

13. A process for producing a polymeric material comprising a polyaryletherketone (PAEK), the process comprising the following steps:

a. polycondensing one or more bisphenol with one or more dihalobenzenoid compound, in the presence of

i. less than 0.005 molar ratio of potassium carbonate, and

ii. one or more carbonate of an alkali metal other than potassium carbonate, in a reactor; and

b. isolating the PAEK.

14. The process according to clause 13, wherein step a of the process is carried out in the presence of less than 0.0045 molar ratio of potassium carbonate, preferably less than 0.0040 molar ratio of potassium carbonate, more preferably less than 0.0036 molar ratio of potassium carbonate, most preferably less than 0.0032 molar ratio of potassium carbonate.

15. The process according to clause 13 or clause 14, wherein step a of the process is carried out in the presence of greater than 0.0001 molar ratio of potassium carbonate, preferably greater than 0.0010 molar ratio of potassium carbonate, more preferably greater than 0.0020 molar ratio of potassium carbonate, most preferably greater than 0.0025 molar ratio of potassium carbonate.

16. The process according to any one of clauses 13 to 15, wherein said one or more carbonate of an alkali metal other than potassium carbonate comprises sodium carbonate.

17. The process according to clause 16, wherein the molar ratio of sodium carbonate used in step a of the process is greater than 1.01, but less than 1.06.

18. The process according to any one of clauses 13 to 17, wherein step a of the process is carried out in the presence of a salt A selected from lithium chloride, calcium chloride, magnesium chloride, lithium bromide, lithium iodide and/or lithium sulphate, preferably lithium chloride.

19. The process according to clause 18, wherein the molar equivalents of salt A (relative to the moles of potassium carbonate present in step a of the process) is at least 1.0 molar equivalents, preferably at least 4.0 molar equivalents, more preferably at least 6.0 molar equivalents, most preferably at least 7.0 molar equivalents.

20. The process according to any one of clauses 13 to 19, wherein step a of the process is carried out in the presence of a molar ratio of dihalobenzoid compound of at least 1.02, but at most 1.05.

21. The process according to any one of clauses 13 to 20, wherein said one or more bisphenol comprises hydroquinone, 4,4′-dihydroxpenzophenone and/or 4,4′-dihydroxybiphenyl, and/or wherein said one or more dihalobenzenoid compound comprises 4,4′-difluorobenzophenone.

22. The process according to any one of clauses 13 to 21, wherein step a of the process is carried out at a temperature of from 100° C. to 390° C., preferably from 120° C. to 350° C., more preferably from 130° C. to 320° C.

23. The process according to any one of clauses 13 to 22, wherein step a of the process is carried out at a temperature that increases to a maximum temperature of greater than 280° C., wherein in step a, after the maximum temperature is reached, said maximum temperature is maintained until a desired molecular weight of the PAEK has been reached, wherein once said desired molecular weight of the PAEK has been reached, one or more end-capping agent is added to the reactor.

24. The process according to clause 23, wherein said end-capping agent is selected from one or more of a monohalobenzenoid compound such as 4-fluorobenzophenone or monochlorodiphenylsulphone, a dihalobenzenoid compound such as 4,4′-difluorobenzophenone or dichlorodiphenylsulphone, methyl chloride and/or difluorodiketone, preferably selected from 4,4′-difluorobenzophenone and/or 4-fluorobenzophenone.

25. The process according to clause 23 or clause 24, wherein greater than 0.008 molar ratio, but less than 0.030 molar ratio of end-capping agent is added to the reactor.

26. The process according to any one of clauses 13 to 25, wherein step a of the process comprises:

a. polycondensing one or more bisphenol with one or more dihalobenzenoid compound, in the presence of

i. greater than 0.0025 molar ratio but less than 0.0036 mole % of potassium carbonate, and

ii. greater than 1.01 molar ratio but less than 1.06 molar ratio of sodium carbonate, in a reactor;

wherein step a of the process is carried out in the presence of diphenylsulphone;

wherein step a of the process is carried out at a temperature of from 130° C. to 320° C., and is carried out at a temperature that increases to a maximum temperature of greater than 290° C. but less than 320° C.;

wherein prior to reaching said maximum temperature, greater than 1.005 molar ratio, but less than 1.010 molar ratio of said one or more dihalobenzenoid compound is brought into contact with said one or more bisphenol;

wherein after the maximum temperature is reached, said maximum temperature is maintained until a desired molecular weight of the PAEK has been reached;

wherein once said desired molecular weight of the PAEK has been reached, one or more end-capping agent is added to the reactor;

wherein greater than 0.009 molar ratio but less than 0.025 molar ratio of end-capping agent is added to the reactor;

wherein step a of the process is carried out in the presence of at least 6.0 molar equivalents but less than 10.0 molar equivalents of lithium chloride;

wherein said lithium chloride is added to the reactor once said desired molecular weight of the PAEK has been reached; and

wherein said lithium chloride is added to the reactor before said end-capping agent or at the same time as said end-capping agent.

27. The process according to any one of clauses 13 to 26, wherein the process is for producing a polymeric material according to any one of clauses 1 to 12.

28. The polymeric material according to any one of clauses 1 to 12, wherein said polymeric material is obtainable by or obtained by the process according to any one of clauses 13 to 27.

29. An article which comprises a polymeric material according to any one of clauses 1 to 12 or 28 or a polymeric material made in the process of any one of clauses 13 to 27.

30. The article according to clause 29, wherein said article is a film, and wherein said film has a gel/black speck level of less than 300 ppm, preferably less than 250 ppm, more preferably less than 200 ppm, even more preferably less than 180 ppm, when measured in accordance with Example 7.

31. Use of the process according to any one of clauses 13 to 27 to provide a PAEK with an increased lightness L*, when measured in accordance with Example 6 and with reference to the 1976 CIE L* a* b* colour space.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A process for producing polyaryletherketone, PAEK, the process comprising:
a) nucleophilic polycondensation of a bisphenol with an organic dihalide compound in a reaction mixture comprising sodium carbonate and potassium carbonate, in an aromatic sulfone solvent, at a reaction temperature rising to a temperature from 290° C. to 320° C. immediately prior to;
b) addition of a salt to the reaction mixture, wherein the molar ratio of the salt to potassium carbonate is from 6.0 to 10.0;
c) addition of further organic dihalide compound to the reaction mixture, simultaneously with or subsequent to step b, wherein the molar ratio of further organic dihalide compound to bisphenol is from 0.009 to 0.035;
d) maintenance of the resulting reaction mixture's temperature at from 290° C. to 320° C. for from 20 to 180 minutes;
e) cooling of the resulting reaction mixture and recovery of the PAEK resulting from steps a to d from the reaction mixture;
wherein in step a of the process:
i) the molar ratio of sodium carbonate to bisphenol is from 0.95 to 1.15;
ii) the molar ratio of potassium carbonate to sodium carbonate is from 0.0025 to 0.0040; and
iii) the molar ratio of organic dihalide compound to bisphenol is from 1.005 to 1.010.

2. The process according to claim 1 wherein the aromatic sulfone solvent is diphenylsulfone.

3. The process according to claim 1 wherein the process is for producing a PAEK that is homopolymer polyetheretherketone;
wherein the bisphenol is hydroquinone; and
wherein the organic dihalide compound and the further organic dihalide compound are 4,4′-difluorobenzophenone.

4. The process according to claim 1, wherein the salt is an alkali metal salt or an alkaline earth metal salt, and optionally, wherein the salt is selected from lithium chloride, calcium chloride, magnesium chloride, lithium bromide, lithium iodide and/or lithium sulphate.

5. The process according to claim 4 wherein the salt is lithium chloride or is lithium sulphate.

6. A polyaryletherketone, PAEK, comprising residual impurities of aromatic sulfone solvent, sodium salt and organic dihalide monomer from its formation by nucleophilic polycondensation;
wherein when the PAEK is dissolved in concentrated sulfuric acid to prepare a resultant solution with 1 g of the PAEK per 100 ml of the resulting solution, the resultant solution has an absorbance contribution from the PAEK of less than 0.20 at a wavelength of light of 550 nm.

7. The PAEK according to claim 6 wherein the PAEK has a polydispersity index PDI=M_{W}/M_{N}, based on polystyrene equivalent molecular masses, of less than 2.5;
wherein M_{w}=weight average molecular mass and Mₙ=number average molecular mass.

8. The PAEK according to claim 6 wherein when the PAEK is in the form of a sample with planar surface, injection moulded from the PAEK as a powder,
the planar surface has:
a lightness L* of greater than 65.0;
an a* coordinate of greater than 0.2 but less than 5.0;
a b* coordinate of greater than 5.0 but less than 12.0;
with reference to the 1976 CIE L* a* b* colour space.

9. The PAEK according to claim 6, wherein the PAEK is homopolymer polyetheretherketone, PEEK, with repeat units consisting of formula II:
—O-Ph-O-Ph-CO-Ph- II
or a copolymer with repeat units consisting repeat units of formula II and repeat units of formula III:
—O-Ph-Ph-O-Ph-CO-Ph- III.

10. The PAEK according to claim 6 wherein the PAEK is homopolymer PEEK.

11. The homopolymer PEEK according to claim 10 wherein the PEEK has an extractable concentration of 0.05 mg/kg or less of residual 4,4′-difluorobenzophenone, when immersed in Miglyol 812 at 175° C. for six hours.

12. The homopolymer PEEK according to claim 10 wherein the residual impurities of aromatic sulfone solvent are present as 0.063% or less by weight in the PEEK, where said aromatic sulfone solvent is diphenylsulfone.

13. The homopolymer PEEK according to claim 10, wherein the PEEK has a critical strain energy release rate of at least 17.5 Jm⁻².

14.-20. (canceled)

21. A method for forming a pipe or sheath by extrusion of a composition comprising or consisting of PAEK according to claim 6.

22. The PAEK according to claim 6 wherein the PAEK is formed into (a) an enclosure for a portable electronic device, (b) a pipe or sheath, (c) a wire wrap, (d) a film, (e) a tape, or (f) a component intended to contact food.

23. The homopolymer PEEK according to claim 10 wherein the homopolymer PEEK is formed into (a) an enclosure for a portable electronic device, (b) a pipe or sheath, (c) a wire wrap, (d) a film, (e) a tape, or (f) a component intended to contact food.
